(19) United States
(12) Patent Application Publication
(10) Pub. No.: US 2011/0022982 A1
(43) Pub. Date: Jan. 27, 2011

(54) DISPLAY PROCESSING DEVICE, DISPLAY PROCESSING METHOD, AND DISPLAY PROCESSING PROGRAM

(75) Inventors: Ryo Takaoka, Tokyo (JP); Akiko Terayama, Tokyo (JP); Qihong Wang, Tokyo (JP); Satoshi Akagawa, Tokyo (JP); Koji Arai, Tokyo (JP); Shunichi Kasahara, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/842,395

(22) Filed: Jul. 23, 2010

(30) Foreign Application Priority Data
Jul. 27, 2009 (JP) P2009-173967

(51) Int. Cl. G06F 3/048

(52) U.S. Cl. 715/810

(57) ABSTRACT

A display processing device includes a display element, a grouping mechanism configured to group such that each of a plurality of selectable items belongs to one or more groups based on information which each item has, an assigning mechanism configured to generate and assign display objects corresponding to related items to the respective groups generated by the grouping of the plurality of selectable items by the grouping mechanism, and a display processing mechanism configured to display the display objects assigned to the groups by the assigning mechanism on a display screen of the display element.

### BACKGROUND OF THE INVENTION

1. Field of the Invention

The present invention relates to a device capable of displaying various information, which has a display element with a relatively large display screen such as a digital video camera, a digital still camera, a portable telephone terminal, or a portable information processing terminal, a method and a program used in the device.

2. Description of the Related Art

Digital cameras have been widely used which take moving images or still images and records them on a recording medium as digital data. Generally, a device used to take moving images is called a digital video camera and a device used to take still images is called a digital still camera, so that they are distinguished from each other, but cameras which can take both moving images and still images are increasing.

The digital video camera which mainly takes moving images typically employs a high capacity recording medium such as a DVD (digital versatile disc) or a hard disc. In addition, the digital still camera which mainly takes still images employs an internal flash memory or various removable memories since still image data uses a smaller amount of data compared to moving images.

In recent years, however, along with the internal flash memory or the removable memories being reduced in size and having high capacity, data compression techniques have improved, so a digital video camera has been also provided in which a large amount of moving-image data is stored in these memories.

As above, for the digital cameras in which a large amount of image data can be recorded in the recording medium, an amount of image data taken is increased as time goes by, and image data is sometimes stored in the recording medium, which is difficult for the user to manage.

In a digital camera in the related art, a lot of image data is stored in a folder generated on the basis of predetermined information such as date or time.

For example, such as a collection of image data which was taken on Jan. 1, 2009, a lot of image data taken at the same photographing date is stored in one folder. In addition, a folder named “athletic meet” or “birthday”, or the like is generated by a user, and image data which was taken and obtained is arranged in the folder.

The folders identified by the date, the time, or the folder name given by the user are used for sorting and storing the image data which was obtained by the user at predetermined events. These folders increase to a degree where they are not managed by the user as the number of years when a digital camera is used increases.

For this reason, in a display processing device such as the digital camera, disclosed in, for example, Japanese Unexamined Patent Application Publication No. 2007-037182 or Japanese Unexamined Patent Application Publication No. 2006-295236 described later, a list display of images or an index screen is used for each folder, and the images can be gazed over.

In addition, if image data are further stored, a narrowing-down search with good efficiency is also necessary. In the related art, for example, as disclosed in Japanese Unexamined Patent Application Publication No. 2008-165424 or Japanese Unexamined Patent Application Publication No. 2005-354134 described later, it is suggested that a search can be efficiently performed using metadata or keywords.

### SUMMARY OF THE INVENTION

However, in the related art method of searching images as disclosed in the above Japanese Unexamined Patent Application Publication No. 2007-037182 and Japanese Unexamined Patent Application Publication No. 2006-295236, in order to find a folder in which desired image data is stored, a user travels back and forth among a number of folders and confirms image data in each folder. Thereby, it is thought that there are cases where there are inconveniences in that an operation is troublesome and it takes time until the desired folder is found.

Also, in the narrowing-down search as disclosed in Japanese Unexamined Patent Application Publication No. 2008-165424 and Japanese Unexamined Patent Application Publication No. 2005-354134, the search is made by selecting classification tags or search keywords which are added to the image data via a GUI (graphical user interface) menu or the like.

In this case, it is thought that there are cases where the selection of the classification tags or the search keywords is troublesome. Furthermore, it is thought that there are cases where the desired image data sometimes is not found in one search. In this case, search results are checked, the classification tags or the search keywords are selected via a GUI menu, and the search is repeated.

Thus, in the narrowing-down search using the classification tags or the search keywords, a user's literacy and labor are necessary for designating a combination of search conditions. Therefore, there is also a problem in that a user who is not accomplished at searching does not refine the search as the user wishes.

So-called portable electronic devices such as video cameras carried and used by a user are frequently used as so-called communication tools. Thus, there are cases where a user wants to quickly and simply search image data or the like stored in the video camera and show it to nearby friends or acquaintances so that they can easily view it.

The issues regarding the search for contents such as the above-described image data are not limited to the above issues.

For example, like a portable telephone terminal, an electronic device has been widely used which has various functions such as a telephone function, an Internet access function, a camera function, a function for reception and reproduction of digital television broadcasts, and a function for storage and reproduction of music data.

In the multi-functional electronic device, in the same manner as the search for the contents such as image data, in a case of setting a desired item to a desired function, a user often actually performs a setting after reaching a screen for setting the desired item through complicated operations.

As above, when searching for desired content in a number of stored contents or searching for a desired item in a number of settable items, complicated operations are performed in the related art, so the operations are desired to be simply performed and easily understood.

It is desirable that a desired item can be quickly and accurately found in a number of selectable items without complicated operations and can be used.

A display processing device according to an embodiment of the invention includes a display element, a grouping means for grouping such that each of a plurality of selectable items belongs to one or more groups based on information which each item has, an assigning means for generating and assigning display objects corresponding to related items to the respective groups generated by the grouping of the plurality of selectable items by the grouping means, and a display processing means for displaying the display objects assigned to the groups by the assigning means on a display screen of the display element.

In the display processing device, the grouping means may group such that a plurality of selectable items may each belongs to one or more groups based on information which each item has.

The assigning means may generate and assign display objects corresponding to related items to the respective groups generated by the grouping of the plurality of selectable items by the grouping means.

The display processing means may display the display objects assigned to the groups by the assigning means on a display screen of the display element.

Thereby, a user does not independently recognize each of a plurality of selectable items, but can recognize groups to which a desired selectable item belongs by the display objects displayed on the display screen of the display element.

It is possible to find the desired selectable item from the recognized groups to which the desired item belongs. Therefore, it is possible to quickly find a desired item from a plurality of selectable items by automatically narrowing down a search range without complicated operations, and to use it.

According to embodiments of the invention, it is possible to quickly find a desired item from a plurality of selectable items without complicated operations, and to use it.

### BRIEF DESCRIPTION OF THE DRAWINGS

FIG. 1 is a block diagram illustrating a configuration example of an imaging device to which a device, a method, and a program according to an embodiment of the invention are applied.

FIG. 2 is a diagram illustrating an arrangement example of image files recorded on a recording medium of the imaging device.

FIG. 3 is a diagram illustrating an example of information for image groups generated by the grouping of the image files in the imaging device.

FIG. 4 is a diagram illustrating an example of an initial screen (application main screen) in a reproduction mode.

FIG. 5 is a diagram illustrating a configuration of a display object indicating each image group on a display screen.

FIG. 6 is a diagram illustrating an example of a screen for searching for image files in the image group.

FIG. 7 is a diagram illustrating an example of a list display for the search result displayed following on from FIG. 6.

FIG. 8 is a diagram illustrating a detailed example of an AND search for image files which designates a number of groups as a target.

FIG. 9 is a diagram illustrating a detailed example of an AND search for image files which designates a number of groups as a target.

FIG. 10 is a diagram illustrating a detailed example of an AND search for image files which designates a number of groups as a target.

FIG. 11 is a diagram illustrating a detailed example of an AND search for image files which designates a number of groups as a target.

FIG. 12 is a diagram illustrating an example where an AND search is made with only one finger.

FIG. 13 is a diagram illustrating an example where an AND search is made with only one finger.

FIG. 14 is a diagram illustrating an example where an AND search is made with only one finger.

FIG. 15 is a flowchart illustrating processings in the reproduction mode in the imaging device.

FIG. 16 is a flowchart following on from FIG. 15.

FIG. 17 is a flowchart following on from FIG. 15.

FIG. 18 is a flowchart following on from FIG. 15.

FIG. 19 is a flowchart following on from FIG. 18.

FIG. 20 is a diagram illustrating a processing in a setting mode.

FIG. 21 is a diagram illustrating a processing in the setting mode.

FIG. 22 is a diagram illustrating a processing in the setting mode.

FIG. 23 is a diagram illustrating a processing in the setting mode.

### DESCRIPTION OF THE PREFERRED EMBODIMENTS

Hereinafter, a device, a method, a program according to an embodiment of the invention will be described with reference to the drawings. For example, a case will be described where the invention is applied to an imaging device (video camera) which can take moving images or still images, record them on a recording medium and use them.

Configuration Example of Imaging Device

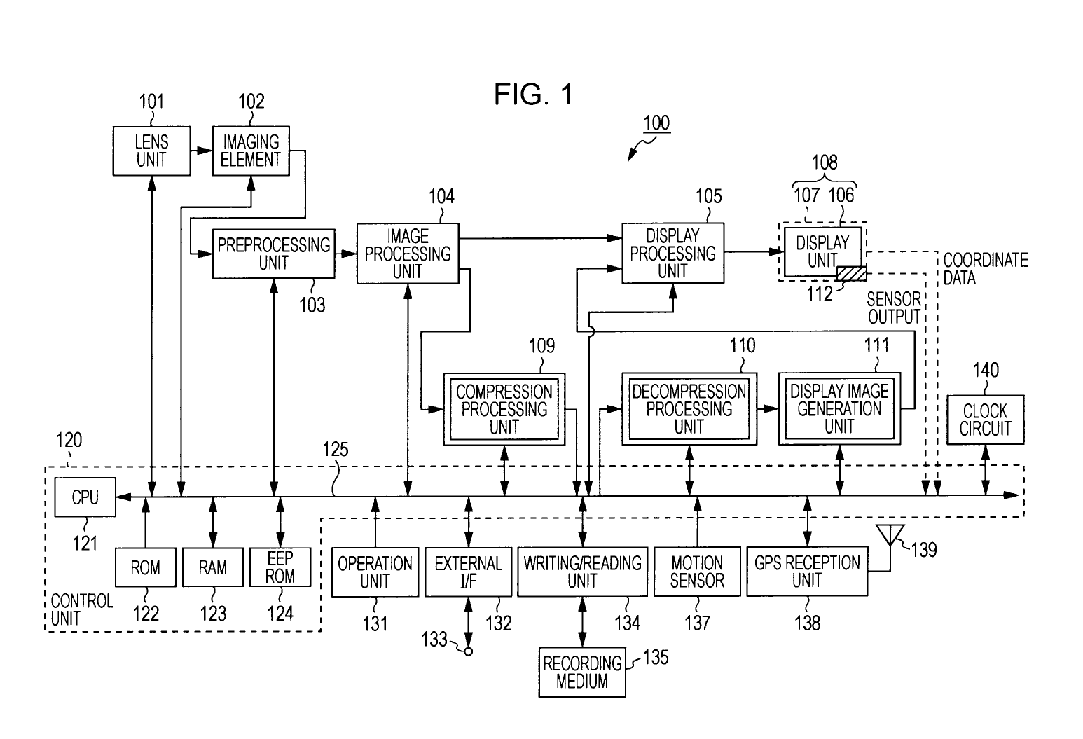

FIG. 1 is a block diagram illustrating a configuration example of an imaging device 100 to which a device, a method, and a program according to an embodiment of the invention are applied. The imaging device 100 can take both still images and moving images and record them on a recording medium by changing a photographing mode.

As shown in FIG. 1, the imaging device 100 includes a lens unit 101, an imaging element 102, a preprocessing unit 103, an image processing unit 104, a display processing unit 105, a display unit 106, a touch panel 107, a compression processing unit 109, a decompression processing unit 110, and a display image generation unit 111.

In addition, the imaging device 100 includes a control unit 120, an operation unit 131, an external interface (hereinafter, abbreviated to an “external I/F”) 132, an input/output terminal 133, a writing/reading unit 134, and a recording medium 135. Further, the imaging device 100 includes a motion sensor 137, a GPS reception unit 138, a GPS reception antenna 139, and a clock circuit 140.

In the imaging device 100 in this embodiment, the display unit 106 is constituted by, for example, a so-called slim type display element such as an LCD (liquid crystal display), or an organic EL (electroluminescence) panel. Although also described later, a display screen of the display unit 106 is provided with the touch panel 107 so that the entire display screen becomes an operation surface.

The touch panel 107 receives an indication operation (touch operation) on the operation surface from a user, detects an indicated position (touched position) on the corresponding operation surface of the touch panel 107, and notifies the control unit 120 of coordinate data indicating the indicated position.

The control unit 120, as described later, controls the respective units of the imaging device 100, and grasps what kind of display is performed on the display screen of the display unit 106. The control unit 120 may receive an indication operation (input operation) from a user, based on the coordinate date indicating the indicated position on the operation surface from the touch panel 107, and display information on the display screen of the display unit 106 corresponding to the related indicated position.

For example, it is assumed that the user touches at a certain position on the operation surface of the touch panel 107 with a finger or a stylus or the like. In this case, when a figure is displayed at the position on the display screen corresponding to (coincident to) the touched position, the control unit 120 can determine that the user selects the displayed figure to be input.

In this way, in the imaging device 100, the display unit 106 and the touch panel 107 form a touch screen 108 as an input device. In addition, the touch panel 107 is implemented by, for example, a pressure-sensing type or an electrostatic type.

The touch panel 107 can detect each of the operations which are simultaneously performed at a plurality of places on the operation surface, and output coordinate data indicating each of the touched positions. In addition, the touch panel 107 can detect each of the indication operations which are repeatedly performed on the operation surface and output coordinate data indicating the respective touched position.

The touch panel 107 can consecutively detect a touched position at predetermined timing while the user touches the operation surface with a finger or a stylus, and output coordinate data indicating it.

Therefore, the touch panel 107 can receive and detect various indication operations (operation inputs) such as so-called tapping, double tapping, dragging, flicking, and pinching.

Here, the tapping is an operation where the user performs an indication by “tapping” the operation surface only once using a finger or a stylus. The double tapping is an operation where the user performs an indication by twice continuously “tapping” the operation surface.

The dragging is an operation where a finger of the user or a stylus is moved in the state where it touches the operation surface. The flicking is an operation where a finger of the user or a stylus indicates one point on the operation surface, and thereafter from that state, quickly “flicks” the finger or the stylus in an arbitrary direction.

The pinching is an operation where two fingers of the user simultaneously touch the operation surface and then the two fingers are opened or closed. In this case, particularly, an operation where the two fingers are opened is called a pinch out operation, and an operation where the two fingers are closed is called a pinch in operation.

The dragging and the flicking are different in operation speed. However, they are operations for moving the operation surface after the fingers or the like touch the operation surface (operations tracing on the operation surface), and operations which can be grasped by two kinds of information such as a movement distance and a movement direction.

For this reason, throughout the specification, when the same processing is performed by using any one of the dragging and the flicking, an all-inclusive term of the dragging and the flicking uses a word “tracing operations.”

The display screen of the display unit 106 of the imaging device 100 in this embodiment is provided with a pressing sensor (pressure sensor) 112. The pressing sensor 112 detects a pressure given to the display screen of the display unit 106, and notifies the control unit 120 of this detected output.

Accordingly, in the imaging device 100 in this embodiment, when the user touches the touch panel 107 with a finger or the like (hereinafter it is also referred to as just “finger”), coordinate data from the touch panel 107 is provided to the control unit 120. At the same time, the detected output from the pressing sensor 112 is provided to the control unit 120.

Thereby, when an indication operation is performed on the touch panel 107, the control unit 120 can not only detect the touched position but also grasp how strongly the position is pressed.

The control unit 120 of the imaging device 100 in this embodiment is connected to the respective units of the imaging device 100 to control the respective units of the imaging device 100, as described above, and is constituted by so-called microcomputers.

The control unit 120 is constituted by a CPU (central processing unit) 121, a ROM (read only memory) 122, a RAM (random access memory) 123, an EEPROM (electrically erasable and programmable ROM) 124, which are connected to each other via a CPU bus 125.

The CPU 121 reads out and executes programs stored in the ROM 122 described later, generates control signals which are supplied for the respective units, receives data or the like from the respective units, and processes them.

The ROM 122, as described above, in advance stores various programs executed in the CPU 121 or various data or the like used for processings. The RAM 123 is mainly used for a work area which temporarily stores intermediate results in various kinds of processings or the like.

The EEPROM 124 is a so-called non-volatile memory, which stores information even when a power supply of the imaging device 100 is out. For example, the EEPROM 124 maintains various parameters set by the user, final results of various processings, or newly provided processing programs or data, due to added functions.

As above, the control unit 120 which is constituted by the microcomputers is, as shown in FIG. 1, connected to the operation unit 131, the external I/F 132, the writing/reading unit 134, the motion sensor 137, the GPS reception unit 138, and the clock circuit 140.

The operation unit 131 is provided with various operation keys such as adjustment keys, function keys, and shutter keys, and receives operation inputs from the user, and notifies the control unit 120 of them. Thereby, the control unit 120 controls the respective units in response to the operation inputs received from the user via the operation unit 131, and performs processings corresponding to the operation inputs.

The external I/F 132 is a digital interface based on a predetermined standard such as USB (universal serial bus), or IEEE (Institute of Electrical and Electronics Engineers Inc.) 1394.

That is to say, the external I/F 132 receives data from an external device connected to the input/output terminal 133 after converting the data into data of a format which can be processed by itself, or outputs data by converting the data into data of a predetermined format.

The writing/reading unit 134 writes data in its recording medium 135 or reads data stored in the recording medium 135, under the control of the control unit 120.

The recording medium 135 is a hard disc with a high storage capacity of, for example, several hundred or more gigabytes, and can store a large amount of moving-image data and still-image data.

In addition, the recording medium 135 may employ a memory card type removable memory which is constituted by semiconductor memories, an internal flash memory, or the like. In addition, the recording medium 135 may employ other removable recording media including an optical disc such as a DVD (digital versatile disc) or a CD (compact disc).

The motion sensor 137 detects a motion of the imaging device 100, and, is constituted by, for example, two-axis or three-axis acceleration sensor. The motion sensor 137 detects a tilted direction and degree when the imaging device 100 is tilted, and notifies the control unit 120 of it.

In detail, the motion sensor 137 can detect in which direction the imaging device 100 is being used. For example, it can detect whether a display screen 106G is used in the state of being longer in width by positioning the imaging device 100 horizontally, or the display screen 106G is used in the state of being longer in height by positioning the imaging device 100 lengthwise.

Also, the motion sensor 137 distinguishes a case where the imaging device 100 is shaken in the horizontal direction from a case where it is shaken in the vertical direction for detection, and notifies the control unit 120. When vibration is given to the motion sensor 137 by, for example, being hit, the motion sensor detects this and notifies the control unit 120.

The GPS reception unit 138 receives predetermined signals from a plurality of satellites via the GPS reception antenna 139, detects a current position of the imaging device 100 by analyzing the signals, and notifies the control unit 120.

By this function of the GPS reception unit 138, the imaging device 100 obtains the current position information at the time of photographing, and adds position information (GPS information) indicating a photographing position to image data as metadata.

The GPS reception unit 138 can be operated or not, for example, depending on instructions from the user, received via the operation unit 131.

The clock circuit 140 has a calendar function and provides current year/month/day, current day of the week, and current time. Also, it realizes a function of a time counter which counts a predetermined time interval if necessary.

By the function of the clock circuit 140, information for a photographing day such as photographing date and time or photographing day of the week can be added to taken image data. Also, by the function of the clock circuit 140, it is possible to realize a self-timer photographing function which can perform photographing by automatically pressing a shutter after a predetermined time has elapsed since a predetermined operation.

By the function of the clock circuit 140, it is possible to count an elapse time since a finger is touched on the touch panel 107 and to allow the control unit 120 to refer to the counted time.

In the imaging device 100 shown in FIG. 1, although not shown in the figure, a lens unit 101 includes an imaging lens (object lens), an exposure control mechanism, a focus control mechanism, a shutter mechanism and so on, and receives an image of a subject to form the image on a sensor plane of the imaging element placed in the following stage.

The imaging element 102 is constituted by an imaging sensor (imaging element) such as a CCD (charge coupled device) or a CMOS (complementary metal oxide semiconductor) image sensor. The imaging sensor 102 receives the image, formed on its sensor plane via the lens unit 101, as an electrical signal (image signal).

In the imaging device 100 in this embodiment, the imaging element 102 is provided with a color filter of a single plate which is determined in advance so as to generate a signal of any one of R (red), G (green), and B (blue) for each pixel.

The image signal which is received via the imaging element 102 is provided to the preprocessing unit 103 placed in the following stage. The preprocessing unit 103 includes a CDS (correlated double sampling) circuit, an AGC (automatic gain control) circuit, and an A/D (analog/digital) converter, and receives the image signal from the imaging element 102 as digital data.

The image signal (image data) which is received via the preprocessing unit 103 is provided to the image processing unit 104. The image processing unit 104, although not shown in the figure, includes a detector circuit, a white balance circuit, a demosaic circuit, a resolution conversion circuit, or other image correction circuit.

The imaging processing unit 104 first generates parameters for various control processings such as parameters for light-exposure (exposure) (hereinafter, “exposure” only) control, focus control, or white balance control, based on the image data from the preprocessing circuit 103.

The parameters for exposure control and the parameters for focus control among the parameters generated in the image processing unit 104 are supplied for the control unit 120. The control unit 120 controls, based on the parameters from the image processing unit 104, the exposure control mechanism or the focus control mechanism of the lens unit 102 so as to appropriately perform the exposure or focus control.

The image processing unit 104 performs for the image data from the preprocessing unit 103 a black level fitting processing, or, as described above, a white balance control processing based on the parameters for white balance control. By the control processings, an image formed by the image data from the preprocessing unit 103 is controlled to have an appropriate tint.

Thereafter, the image processing unit 104 performs, for the image data which is controlled to have an appropriate tint, a demosaic processing for generating RGB data (three primary colors data) for each pixel (simultaneity processing), an aperture correction processing, a gamma (γ) correction processing or the like.

In addition, the image processing unit 104 performs a Y/C conversion processing, a chromatic aberration processing, a resolution conversion processing, or the like for generating a luminance signal (Y) and color signals (Cb, Cr) from the generated RGB data, and generates the luminance signal Y and the color signals Cb and Cr.

The image data (the luminance signal Y, the color signals Cb and Cr) generated in the image processing unit 104 is provided to the display processing unit 105, where it is converted into an image signal with a format for being provided to the display unit 106 and then is provided to the display unit 106.

Thereby, an image of a subject which is received via the lens unit 101 is displayed on the display screen of the display unit 106. The user checks images of the subject displayed on the display screen of the display unit 106 and takes images of a desired subject.

At the same time, the luminance signal Y and the color signals Cb and Cr generated in the image processing unit 104 are provided to the compression processing unit 109. In a moving-image capturing mode, when a record key (REC key) of the operation unit 131 is operated, the imaging device 100 starts recording image data of images which are continuously received to itself on the recording medium 135.

In other words, as described above, image data of images which are continuously received via the lens unit 101, the imaging element 102, the preprocessing unit 103, and the image processing unit image processing unit 104, is provided to the compression processing unit 109.

Also, in a still image capturing mode, when the shutter key of the operation unit 131 is operated, image data in amount of one screen which has been received via the lens unit 101, the imaging element 102, the preprocessing unit 103, and the image processing unit 104 at that time, is provided to the compression processing unit 109.

The compression processing unit 109 compresses the image data, which has been provided, by a predetermined data compression scheme, and provides the data-compressed image data to the writing/reading unit 134 via the control unit 120.

The compression processing unit 109 may use the MPEG (moving picture experts group) 4 scheme or the H.264 scheme for moving pictures, and may use the JPEG (joint photographic experts group) scheme or the like for still images. Of course, the data compression scheme is not limited thereto, but may use various schemes.

The control unit 120 controls the writing/reading unit 134, and records the data-compressed image data from the compression processing unit 109 on the recording medium 135 as a file. In this way, the imaging device 100 takes images of a subject and records image data for generating the images of the subject on the recording medium 135.

The image data recorded on the recording medium 135 is read by the writing/reading unit 134 under the control of the control unit 120. The image data read from the recording medium 135 is provided to the decompression processing unit 110 via the control unit 120.

The decompression processing unit 110 decompresses the provided image data by the data compression scheme which has been used at the time of the data compression so as to restore the image data before the data compression, and provides the decompressed data to the image generation unit 111.

The image generation unit 111 generates image data of images which will be displayed on the display screen of the display unit 106, by the use of the image data from the decompression processing unit 110, and, if necessary, by the use of various display data provided from the control unit 120, and provides the generated image data to the display processing unit 105.

The display processing unit 105 converts, in the same manner as the case where it processes the image data from the image processing unit 104, the image data from the display image generation unit 111 into an image signal with a format for being provided to the display unit 106, and then provides it to the display unit 106.

Thereby, images corresponding to the image data recorded on the recording medium 135 are displayed on the display screen of the display unit 106. In other words, image data of a desired image recorded on the recording medium 135 is reproduced.

In this way, the imaging device 100 in this embodiment takes images of a subject, and records them on the recording medium 135. In addition, the imaging device 100 reads the image data recorded on the recording medium 135 to be reproduced, and displays images corresponding to the related image data on the display screen of the display unit 106.

In the imaging device 100 having the above-described configuration, as described below, it is possible to add information which becomes a candidate of search keys (search conditions) such as keywords to image files recorded on the recording medium 135 by photographing.

Although the detailed description is made later, the imaging device 100 in this embodiment can automatically group image data (image files) recorded on the recording medium 135 by photographing, based on metadata such as added keywords.

The grouped image data can be arranged by group unit to be shown to the user. The image data can be confirmed by group unit without complicated operations, or image data common to a plurality of groups can be searched.

Configuration Example of Image File and Image Group

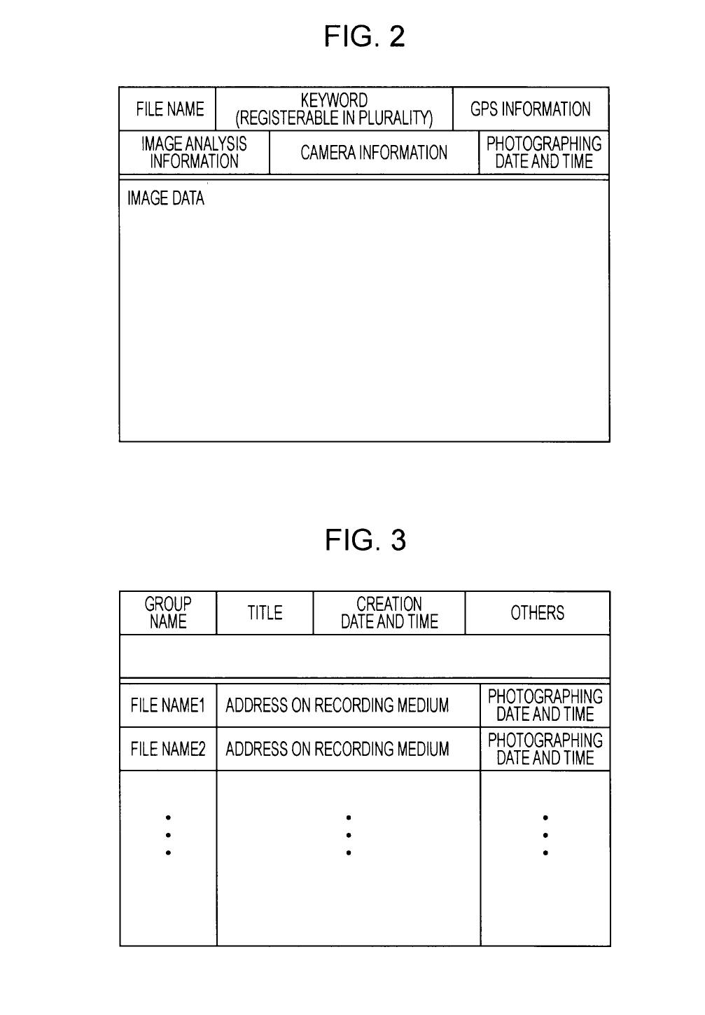

FIG. 2 is a diagram illustrating an arrangement example of image files recorded on the recording medium 135 of the imaging device 100. As shown in FIG. 2, the image file has a file name which is identification information for identifying each file. This file name is, for example, automatically given by the control unit 120 at the time of photographing.

Metadata formed by keywords, GPS information, image analysis information, camera information, photographing date and time or the like, is added to each image file. This metadata may be used as information corresponding to search keys of image data.

Here, the keywords are mainly text data input by the user. In detail, the keywords include a place name indicating a place where the user went photographing, a name of a person of which an image is taken, an event name held at a place where the user went photographing or like, and a plurality of information indicating contents of the related images can be registered.

The keywords are input and added to the related image file via the operation unit 131 or the touch screen 108, when images corresponding to image data of the image file to which the keywords are added are displayed on the display screen of the display unit 106.

For example, it is possible that various metadata such as the keywords is added to the image data on a personal computer, the imaging device 100 receives them via the input/output terminal 133 and the external I/F 132 to be recorded on the recording medium 135. That is to say, the imaging device 100 may receive the image data to which metadata such as the keywords are added using an external device, and may use it.

The GPS information is position information (information for longitude and latitude) indicating a position at the time of photographing, which is obtained via the above-described GPS reception unit 138 at the time of photographing, and is added to the image file via the control unit 120.

The image analysis information is suitable for being applied particularly to still images. An image analysis result is obtained by image-analyzing image data of the related image file using a predetermined scheme, and the obtained result is stored in each image file. The image analysis is performed by the function of the control unit 120 at a proper timing after photographing and then added to the image file.

The image analysis information indicates features of images by each image data by numerical conversion, using various methods such as edge detection or color analysis, and enables compositions between the respective images or similarities between the respective subjects to be compared with each other.

In addition, the image analysis information enables, based on the image analysis result, images with similar persons (faces) to be searched, images with similar places to be searched, or images with similar features in tint or complexity to be searched.

In addition, the image analysis information is information obtained as a result of image analysis, and also includes various analysis information such as an area of a person's face in an image, the number of persons in an image, a degree to which people in an image are smiling, and information indicating a feature of a whole image.

The camera information includes an aperture and a shutter speed at the time of photographing, and such information is maintained by the control unit 120, and is added to the image file by the control unit 120 when photographing is performed.

The photographing date and time is obtained by the control unit 120 via the clock circuit 140, which is date and time information added to the image file, and information formed by year/month/day and time.

The image files stores image data, as main data, for generating an image of a subject obtained by photographing. The image file generated in this way is recorded on the recording medium 135 of the imaging device 100.

In the imaging device 100 in this embodiment, the control unit 120 can group the image files recorded on the recording medium 135 according to the aspect shown in FIG. 2, based on the metadata such as the added keywords.

For example, a group of image files having the same keywords may be generated, or a group of image files belonging to the same area may be generated based on the GPS information. In addition, based on the image analysis information, a group of image files where the images are similar to each other may be generated, or a group of image files where the images contain the same person may be generated.

Based on the photographing date and time, there may be generation of groups corresponding to a period of time, such as, a group taken within the last week, a group of taken within the last month.

FIG. 3 is a diagram illustrating an arrangement example of image groups which are automatically generated in the imaging device 100, for example, in the recording medium 135. As shown in FIG. 3, the image groups have group names for identifying the respective groups. These group names are automatically given by the control unit 120 when the groups are generated by execution of the grouping.

In addition, each image group has a title of the related image group, creation date and time, and other various metadata.

The title is information indicating that the image group is grouped based on what kind of information added to the image file. For example, the keywords used in the group the GPS information, the image analysis information, the information indicating the period of time can be used as the title.

In detail, although a detailed description will be made later, for example, for an image group in which image files having a keyword “Odaiba,” which is a name of an area, are collected, “Odaiba” may be used as a title. Also, for an image group in which image files taken within the past one week with respect to a current day as a reference day are collected, “one week” may be used as a title.

For an image group in which image files are collected based on the GPS information, an area name of an area specified by the GPS information or the very GPS information which is centered may be used a title. Also, for an image group in which image files are collected based on the image information, a comprehensive name, for example, “similar image 1” or “similar image 2” may be used as a title.

The creation date and time is information indicating the date and time when the related image group was created, which is obtained by the control unit 120 from the clock circuit 140.

In addition, as metadata, it is possible to add information which can be automatically given by the imaging device 100, for example, the number of image files, or to add comment information (character information) input by the user.

In an image group, file names of the respective image files belonging to the image group (grouped), addresses on a recording medium, and photographing date and time are stored. Although not shown in FIG. 3, for example, there may be addition of information indicating classification of whether each image file is a moving image or a still image.

Thereby, each image group generated by grouping image files stores the photographing date and time or kinds of image files, and it can be grasped where such image files are stored on the recording medium.

In this way, in the imaging device 100 in this embodiment, when the image is taken, the image data obtained by taking the image is recorded on the recording medium 135 according to the aspect shown in FIG. 2.

The image files stored in the recording medium 135 are grouped to constitute data for maintaining the image groups according to the aspect shown in FIG. 3.

The image file where a plurality of keywords is added may belong to a plurality of image groups. Likewise, an image file for images taken within the past one week belongs to not only a group of images taken within the past one week but also a group of images taken within the past one month. As such, in the imaging device 100, one image file may belong to a plurality of image groups.

Also, the grouping may be automatically performed at a preset timing, for example, after completion of photographing or immediately after switching to the reproduction mode. Of course, the grouping may be performed for all the image files at a proper timing designated by the user.

When the grouping was performed once, image groups of images taken within a predetermined period of time with respect to a current point in time as a reference, for example, “within the past one week” or “within the past one month” may be grouped again at a predetermined timing.

For the remaining image groups, when new images are taken, the grouping may be performed for only the new images. In this way, the repetitive grouping can be quickly completed, and a load on the imaging device 100 can be reduced.

Also, as described above, the grouping of the image files may be performed based on the keywords, the GPS information, the image analysis information, the photographing date and time, which are metadata of the image files. Thereby, the grouping may be performed using the respective metadata of the image files, for example, the grouping may be performed using the GPS information (position information) without converting it into information for a name of an area or the like.

However, for convenience of the description below, it will be described that, for example, the grouping of the image files is performed based on the keywords and the photographing date and time. That is to say, in the imaging device 100, it is assumed that names of persons who were photographed, and a name of a place or a name of an area which were photographed, are added to image files obtained by photographing as keyword information.

The control unit 120 refers to the keyword information for each image file, groups image files with the same name as one group, and groups image files with a name of the same place or a name of the same area as one group.

Also, the control unit 120 refers to the photographing date and time for each image file, and groups the images files based on the photographing date and time, for example, a group of image files taken within the past one week or a group of image files taken within the past one month, with respect to the present (current point in time) as a reference.

As above, in this embodiment, the grouping is performed, as a grouping reference, using the person's name which is a keyword of the image file (information for persons), the name of a place or the name of an area (information for places), the photographing date and time (information for time).

Display Aspect of Image Group and Method of Using Image Group

A browsing method of the image data (image files) recorded on the recording medium 135, which is performed in the imaging device 100 in this embodiment, will be described in detail. Hereinafter, it will be described that, for example, a number of moving-image files have been already recorded on the recording medium 135 of the imaging device 100 and they have been grouped to generate a plurality of image groups.

Initial Screen in the Reproduction Mode

The imaging device 100 in this embodiment has various kinds of modes, such as a moving-image capturing mode, a still image capturing mode, a setting mode of setting parameters (maintenance mode), or a reproduction mode of image files stored in the recording medium 135. These various kinds of modes can be changed using the operation unit 131.

In the imaging device 100 in this embodiment, for example, when changed to the reproduction mode using a mode changing switch of the operation unit 131 when it is turned on, an initial screen in the reproduction mode is displayed.

When the imaging device 100 is turned on in the state where the mode changing switch of the operation unit 131 selects the reproduction mode, it works as the reproduction mode and displays the initial screen in the reproduction mode.

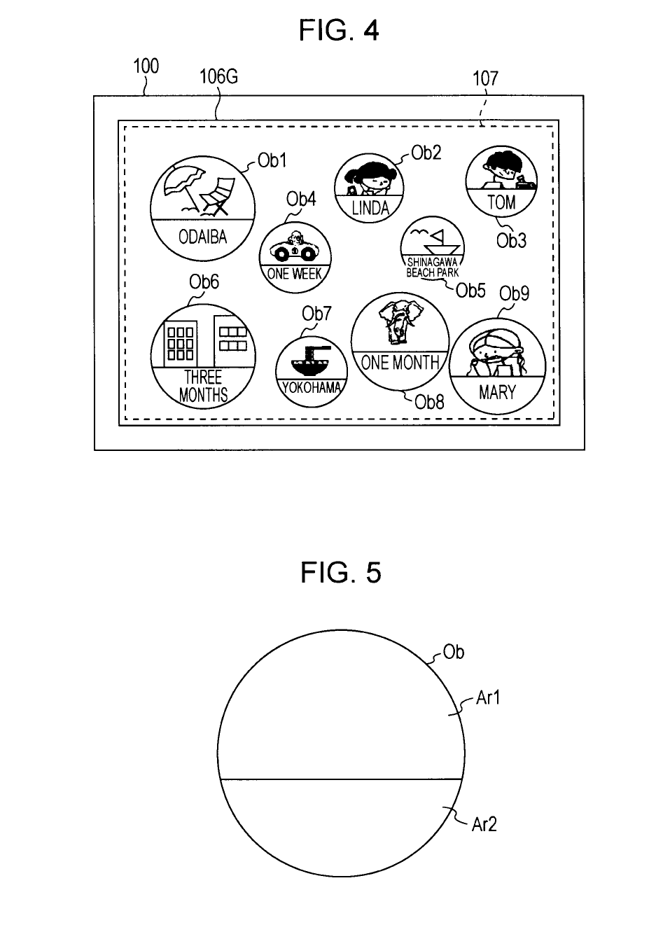

FIG. 4 is a diagram illustrating an example of the initial screen (application main screen) in the reproduction mode where recorded image files can be reproduced.

The initial screen in the reproduction mode as shown in FIG. 4 is, as described above, generated based on the information for the image groups generated in the recording medium 135 as shown in FIG. 3.

In the imaging device 100, as described above, the image files (image data) recorded on the recording medium 135 by photographing are grouped at a predetermined timing. Thereby, as described with reference to FIG. 3, for example, the information for maintaining the image groups to which the respective image files belong is generated in the recording medium 135.

As described above, in the imaging device 100, the grouping is performed based on the keywords and the photographing date and time which are metadata added to the image files. The keywords added to the image files which are recorded on the recording medium 135 typically may use a name of a person who was photographed or a name of a place which was photographed.

In the imaging device 100 in this embodiment, the grouping has been performed based on a person (a name of a photographed person) and a place (a name of a place where the user went photographing), which are keyword information, and photographing date and time which is time information.

In detail, in the imaging device 100, a number of moving-image files are recorded on the recording medium 135, which are grouped into nine image groups based on a “person,” a “place,” and a “time” as shown in FIG. 4.

In the imaging device 100, based on the keyword “a person's name,” there is generation of a group of images containing a person named “Linda,” a group of images containing a person named “Tom,” and a group of images containing a person named “Mary.”

Also, in the imaging device 100, based on the keyword “a name of a place,” there is generation of a group of images taken at “Odaiba,” a group of images taken at “Shinagawa Beach Park,” and a group of images taken at “Yokohama.”

Also, in the imaging device 100, based on “photographing date and time,” there is generation of a group of images taken within the past “one week,” a group of image taken within the past “one month,” and a group of images taken within the past “three months.”

In FIG. 4, a display object Ob1 corresponds to the group of images taken at “Odaiba.” A display object Ob2 corresponds to the group of images containing a person named “Linda.” A display object Ob1 corresponds to the group of images containing a person named “Tom.”

In FIG. 4, a display object Ob4 corresponds to the group of images taken within the past “one week.” A display object Ob5 corresponds to the group of images taken at “Shinagawa Beach Park.” A display object Ob6 corresponds to the group of images taken within the past “three months.”

Also, in FIG. 4, a display object Ob7 corresponds to the group of images taken at “Yokohama.” A display object Ob8 corresponds to the group of images taken within the past “one month.” A display object Ob9 corresponds to the group of images containing a person named “Mary.”

As above, in the initial screen in the reproduction mode shown in FIG. 4, the respective display objects Ob1 to Ob9 are grouped by elements of “person,” “place,” and “time,” and show the image groups which are collections of a plurality of moving-image files having the same elements (attributes).

Using the initial screen in the reproduction mode shown in FIG. 4, a number of moving-image files recorded on the recording medium 135 can be treated as reproducible moving-image files.

FIG. 5 is a diagram illustrating a configuration of the display object Ob which is assigned to each image group and refers to each image group on the display screen. As shown in FIG. 5, the display object Ob is constituted by an image display area Ar1 and a title display area Ar2.

The display area Ar1 is an area for displaying images generated by image data of image files each of which belongs to the image group corresponding to the related display object Ob.

As described above, in the imaging device 100 in this embodiment, a number of moving-image files recorded on the recording medium 135 are targeted at reproduction. For this reason, moving images by image data of moving-image files belonging to the image group corresponding to the display object Ob are clipped to be reproduced in the image display area Ar1.

Here, the clipped reproduction of the moving images displays such that the respective moving files belonging to the related image group can be recognized by sequentially reproducing a part of each of the image files belonging to the related group.

In detail, the respective moving-image files belonging to the related image group are reproduced one by one for a constant time from a predetermined position. In this case, the predetermined position, which is a reproduction start position for each moving-image file, may be a preset position such as a heading of the moving-image file or a position after a predetermined time has elapsed from the heading.

Alternatively, the predetermined position may be a position where the movement of images is great, which is found by analyzing image data, or a position where voices start to rise, which is found by analyzing audio data reproduced in synchronization with the related moving images.

An end position in the reproduction range may be a position after a preset time has elapsed from the reproduction start position, or a position where scenes are changed, which is found by analyzing image data.

Also, based on the number of moving-image files belonging to an image group, a reproduction time of moving images may be set by image data of each moving-image file. In addition, the respective image files may be different from each other in the reproduction time depending on an amount of data for each moving-image file belonging to an image group.

The title area Ar2 of the display object Ob displays the title in the image group shown in FIG. 3. In other words, it displays a keyword common to image files belonging to an image group indicated by the display object Ob, or information indicating a division of time.

As shown in FIG. 4, the respective display objects Ob1 to Ob9 are different from each other in their sizes. The sizes of the respective display objects Ob1 to Ob9 correspond to the number of image files belonging to image groups indicated by the respective display objects.

A display object for an image group having a large number of image files is made to have a larger diameter. Therefore, based on the size of the display object Ob, the number of image files collected in the image group is grasped, and, for example, it is possible to predict time taken to review all of the image files, which is referred to in the subsequent processing.

Here, although the size of the corresponding display object Ob varies depending on the number of image files belonging to an image group, the invention is not limited thereto. For example, the size of the display object may vary depending on an amount of data.

For example, even when only one image file belongs to an image group, if the image file is taken for a relatively long time, the size of a corresponding display object is made larger. Thereby, an amount of image data of image files belonging to an image group is roughly grasped, and, for example, it is possible to predict an actual reproduction time, which is referred to in the subsequent processing.

As described above, in the imaging device 100 in this embodiment, for the image files recorded on the recording medium 135, the image files having the same keyword are grouped so as to belong to the same image group.

In the imaging device 100 in this embodiment, the image files are grouped into, using a current day as a reference, the group of images taken within the past one week, the group of images taken within the past one month, and the group of images taken within the past three months.

In detail, the image groups based on a “person” can be said to be collections of picture scenes which contain persons (who had their picture taken and) who the user met in the past from the current time in point.

The image groups based on a “place” can be said to be collections of picture scenes taken at places (which had their picture taken and) which the user went to in the past from the current time in point, or picture scenes taken at a place where the user is at the present.

In addition, the image group based on “time” can be said to be collections of picture scenes taken at a certain period of time, such as today, last week, last month, last three months, last six months, or last year, which goes back to the past.

Accordingly, in FIG. 4, the display object Ob1 refers to find all of the moving-image files taken at “Odaiba” in the past, and, in the image display area Ar1 of the display object Ob1, a part of each moving image for the moving-image files taken at “Odaiba” is reproduced one by one.

The control unit 120 displays the aspect shown in FIG. 4 by controlling, based on the information for the image groups generated as shown in FIG. 3, the writing/reading unit 134, the decompression processing unit 110, the display image generation unit 111, and the display processing unit 105.

The control unit 120 provides to the display image generation unit 111 information used for displaying the display object corresponding to each image group based on the information for each image group generated as shown in FIG. 3. The display generation unit 111 generates a display object assigned to (corresponding to) each image group based on the provided information. In this case, it is possible to determine the size of a display object assigned to each image group based on the number of image files belonging to each image group provided from the control unit 120.

At this time, in order to display moving images in the image display area Ar1 of each display object, the control unit 120 controls the writing/reading unit 134 based on the information for each image group, and reads moving-image data in a desired amount from moving-image files belonging to each image group.

The moving-image data read by the writing/reading unit is provided to the decompression processing unit 110 via the control unit 120 which is decompressed here, and then is provided to display image generation unit 111.

The display image generation unit 111 adjusts the size or shape of moving images for the provided moving-image data, depending on the image display area Ar1 of the corresponding display object under the control of the control unit 120. The display image generation unit 111 makes the adjusted moving-image data exactly fit the image display area Ar1 of the corresponding display object.

In this way, the display image generation unit 111 assigns the display object to each image group to be generated, arranges it at a predetermined position on the display screen, and generates image data for display.

Thereafter, the display image generation unit 111 provides the generated image data to the display processing unit 105. The display processing unit 105 generates image signals provided to the display unit 106 using the provided image data, and provides it to the display unit 106.

According to the aspect shown in FIG. 4, on the display screen 106G of the display unit 106, the display objects corresponding to the respective image groups are displayed. The adjusted moving-image data for the image displayed in the image display area Ar1 of each display object is stored in, for example, a memory in the display image generation unit 111, and is repeatedly used by the display image generation unit 111.

When, in the display state shown in FIG. 4, a position indicating a desired display object is tapped on the touch panel so as to select the desired display object, the display screen is changed to a moving-image reproduction screen.

The moving-image reproduction screen displays, on the entire display screen, digest reproduction images for moving images of image files belonging to the image group corresponding to the selected display object.

The control unit 120 sequentially reads moving-image data in a desired amount from each of the image files belonging to the image group corresponding to the selected display object, and provides it to the decompression processing unit 110.

The decompression processing unit 110 decompresses the provided moving-image data, and provides the decompressed moving-image data to the display image generation unit 111. The display image generation unit 111 generates image data provided to the display processing unit 105, using the decompressed moving-image data, and provides it to the display processing unit 105.

The display processing unit 105 generates, as described above, image signals provided to the display unit 106 using the provided moving-image data, and provides them to the display unit 106. Thereby, on the display screen 106G of the display unit 106, the respective moving images of the moving-image files belonging to the image group selected as described above are sequentially reproduced for a constant time to perform the digest reproduction.

Even in the case of the digest reproduction of the moving images of the moving-image files belonging to the selected image group, the reproduction of the moving images is performed for a constant time from a predetermined position. In this case, the predetermined position, which is a reproduction start position for each moving-image file, may be a preset position such as a heading of the moving-image file or a position after a predetermined time has elapsed from the heading.

Alternatively, the predetermined position may be a position where the movement of images is severe, which is found by analyzing image data, or a position where voices start to rise, which is found by analyzing audio data reproduced in synchronization with the related moving images.

An end position in the reproduction range may be a position after a preset time has elapsed from the reproduction start position, or a position where scenes are changed, which is found by analyzing image data.

Also, based on the number of moving-image files belonging to an image group, a reproduction time of moving images may be set by image data of each moving-image file. In addition, the respective image files may be different from each other in the reproduction time depending on an amount of data for each moving-image file belonging to an image group.

Thereby, it is possible to accurately know what kind of moving-image files belong to the selected image group, to find a desired image file, and to reproduce it.

The reproduction for only a desired image file may be performed by a predetermined operation, for example, by tapping on the touch panel 107 at the time of the digest reproduction of the desired image file.

Search For Image Files in One Image Group

As described above, in the initial screen in the reproduction mode shown in FIG. 4, when the tapping on a desired display object is performed, the digest reproduction of the image files belonging to the image group corresponding to the display object is performed.

On the other hand, there may be a case where, in an image group corresponding to a desired display object, a desired moving-image file is searched and desired moving-image data is reproduced. For this reason, in the initial screen in the reproduction mode shown in FIG. 4, if a constant time has elapsed in the state where a finger is touched on the touch panel at a display position of a desired display object, the display screen is changed to a search screen for image files in the selected image group.

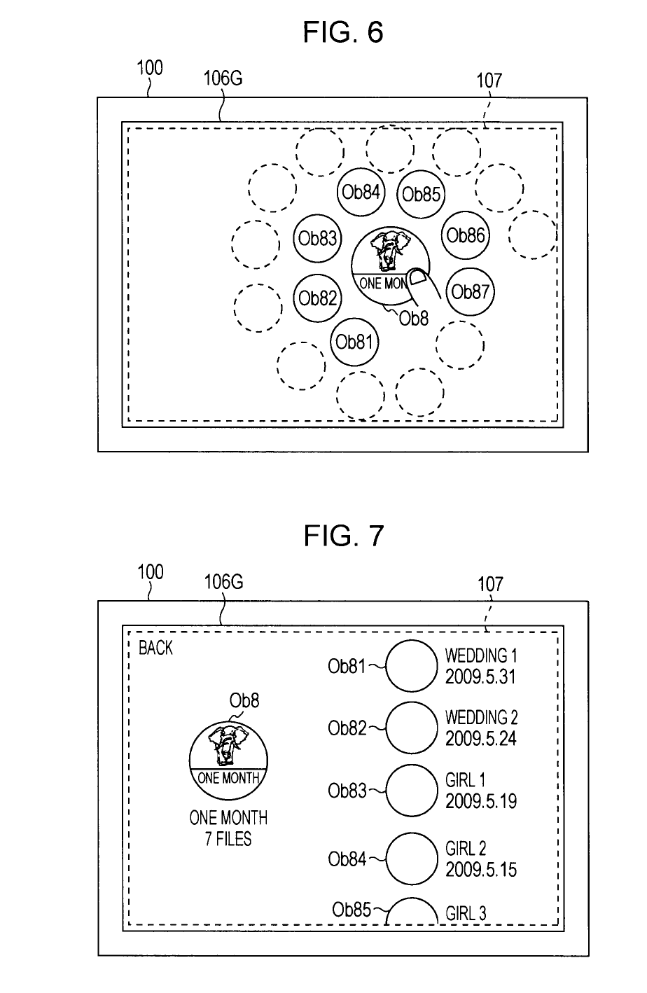

FIG. 6 is a diagram illustrating an example of a search screen for image files in an image group. In the initial screen in the reproduction mode shown in FIG. 4, it is assumed that a user's finger is touched on the touch panel 107 at a display position of the display object Ob8, and such a state lasts for a constant time.

The control unit 120 detects the state based on a display position on the display screen of each display object, which is grasped by it, coordinate data sequentially provided from the touch panel 107, and time counted by the clock circuit 140.

When the control unit 120 detects that a user's finger is touched on the touch panel 107 at the display position of the display object Ob8, and the state lasts for a constant time, it controls such that the search screen for image files in the image group shown in FIG. 6 is displayed.

In this case, the control unit 120 controls the writing/reading unit 134 based on the information for the image group corresponding to the display object Ob8 generated in the recording medium 135, and reads image data in the heading portion of each of the moving-image files belonging to the image group.

The control unit 120 provides the read moving-image data to the decompression processing unit 110. The decompression processing unit 110 decompresses the provided moving-image data and provides the decompressed moving-image data to the display image generation unit 111.

The control unit 120 controls the display image generation unit 111 and generates the search screen for image files in the image group shown in FIG. 6, by using the information for generating the prepared display object Ob8, and the moving-image data provided from the decompression processing unit 110.

In other words, in the periphery of the display object Ob8 selected by the user, thumbnail images of the moving-image files belonging to the related image group are generated, and these are spirally arranged as display objects Ob81 to Ob87.

In this case, the control unit 120 controls the number of the thumbnail of the image files in response to a pressure given, which is detected by the pressing sensor 112 provided in the display unit 106, to the display screen by the user. That is to say, the thumbnail images of the moving-image files belonging to the selected image group are displayed more in proportion to the pressure given to the display screen of the display unit 106.

Thereby, the user can adjust the number of the thumbnails corresponding to the moving-image files displayed in the periphery of the display object Ob8, and can search a thumbnail image corresponding to a desired moving-image file.

In the information for the image groups, the moving-image files belonging to the image groups are arranged to be stored in the order of new photographing date, and when the display screen is pressed further strongly, a thumbnail image of a moving-image file of which photographing date is older may be displayed.

On the search screen for the image files in the image group shown in FIG. 6, the seven thumbnail images of the moving-image files belonging to the related image group are displayed. If a pressure on the display screen 106G is increased, more thumbnail images of moving-image files may be displayed as indicated by the dotted circles, in the case where more moving-image files exist in the related image group.

In this way, the search for a moving-image file belonging to a desired image group is performed, and thereafter, when a finger having touched on the display object Ob8 is released from it, the display screen is changed to a list display of the search result.

Here, the pressure given to the display screen 106G is considered, but the invention is not limited thereto. For example, instead of the detection of pressure variation or along with the detection of pressure variation, a touch time may be considered which is a time when the user touches the display screen 106G with a finger. The touch time when the user touches the display screen 106G with a finger may be counted by the clock circuit 140 counting a supply lasting time of the detection output from the touch panel 107.

FIG. 7 is a diagram illustrating an example of a list display of a search result displayed following on from FIG. 6. In the list display of the search result shown in FIG. 7, the display object Ob8 regarding the image group which is the search target is displayed in the left center of the display screen 106G, and the thumbnail images of the moving-image files belonging to the related image group are displayed in the right of the display screen 106G.

In this case, the thumbnail image of the moving-image file, which are positioned in the center among the thumbnail images of the moving-image files to be displayed in the search screen shown in FIG. 6, is positioned in the center in the longitudinal direction of the display screen, as shown in FIG. 7.

The seven thumbnail images Ob81 to Ob87 are displayed on the search screen shown in FIG. 6. Thereby, the thumbnail image Ob83 is displayed to be positioned in the center in the longitudinal direction of the display screen on the list display of the search result shown in FIG. 7.

In this way, the list display of the search result shown in FIG. 7 is performed. Also, in the list display of the search result shown in FIG. 7, the thumbnail images corresponding to the moving-image files can be scrolled in the longitudinal direction of the display screen.

Thereby, not only the thumbnail image of the moving-image files displayed on the search screen shown in FIG. 6 but also thumbnail images of all the moving-image files belonging to the related image group can be displayed to be viewed.

In addition, the display aspect (pattern) is an example, and, it is possible to display the thumbnail images by various aspects, for example, older ones from the top, older ones from the bottom, newer ones from the top, newer ones from the bottom.

In the list display of the search result shown in FIG. 7, when a thumbnail image of a desired moving-image file is tapped, moving images of the moving-image file are reproduced.

The control unit 120 grasps in which portion a thumbnail corresponding to a moving-image file is displayed on the display screen. Thus, the thumbnail image selected by the tapping is specified, and the moving-image file corresponding to the thumbnail image is specified to be reproduced.

The reproduction of the selected moving-image file is performed by the control unit 120 using the writing/reading unit 134, the decompression processing unit 110, the display image generation unit 111, and the display processing unit 105.

Since the list display of the search result shown in FIG. 7 is generated by using the data used for displaying the search screen for the image files in the image group shown in FIG. 6, it is not necessary to read new image data.

In the display of the display object Ob8 shown in FIGS. 6 and 7, in the same manner as shown in FIG. 4, moving images of the moving-image file belonging to the related image group can be digest-reproduced in the image display area Ar1.

In the list display of the search result shown in FIG. 7, the selection of the icon “BACK” in the top leftmost enables the display screen to return to the initial screen in the reproduction mode shown in FIG. 4.

Also, in the examples shown in FIGS. 6 and 7, although the thumbnail images of the moving-image files are displayed in the periphery of the display object Ob8, the thumbnail images may be still images, or moving images which are reproduced for a constant time.

Also, here, it has been described that the moving-image files belonging to the image group are arranged to be stored in the order of new photographing date, and when the display screen is pressed further strongly, thumbnail images of moving-image files of which photographing date is older are displayed. However, the invention is not limited thereto.

In contrast, the moving-image files belonging to the image group are arranged to be stored in the order of old photographing date, and when the display screen is pressed further strongly, thumbnail images of moving-image files of which photographing date is newer may be displayed.

In each image group generated by the grouping, for example, a photographing frequency for a name of a place or a name of an area included in keywords is found, and the image files are arranged to be stored based on the photographing frequency.

In this case, based on a place, thumbnail images are invoked in the order of a high photographing frequency for a place where the images were taken, or in the order of a low photographing frequency, and when the display screen is pressed further strongly, thumbnails may be displayed which correspond to moving-image files taken at a place of which the photographing frequency is lower or higher.

In each group generated by the grouping, for example, an appearance frequency for a person's name included in keywords is found, and the image files are arranged to be stored based on the appearance frequency.

In this case, based on an image of a person of interest, thumbnail images are invoked in the order of a high frequency for the images of the person, or in the order of a low frequency, and when the display screen is pressed further strongly, thumbnails may be displayed which correspond to moving-image files containing the images of the person whose appearance frequency is lower or higher.

By employing the GPS information and using a current position as a reference, thumbnails of moving-image files taken at a place closer to the current position may be first displayed, or, alternatively, thumbnail of moving-image files taken at a place farther from the current position may be first displayed.

In addition, based on the image analysis information of the moving-image files, thumbnail images of moving-image files containing more persons may first come, or alternatively thumbnail image of moving-image files containing fewer people may first come.

In this way, the thumbnail images corresponding to the moving-image files displayed according to the pressure may be displayed in a proper order, based on the keywords, the photographing date and time, the GPS information, and the image analysis information, which are added to the moving-image files.

AND Search for Image Files in Plural Groups

In the example described with reference to FIGS. 6 and 7, the search is performed for the image files in one image group. However, the search for image files commonly belonging to plural image groups, that is, the AND search may be desired to be performed.

In the imaging device 100 in this embodiment, the AND search for image files, which targets plural groups, can be performed.

To begin with, an outline of the AND search for image files, which targets plural groups, will be described. It is assumed that when the initial screen in the reproduction mode is displayed as shown in FIG. 4, a finger is touched on the touch panel 107 at a display position of a certain display object.

In the case, the other display objects with no relation to the selected display object are removed from the display. That is to say, the display objects for the image groups are removed, which have only image files including no information common to references (a person's name, a name of a place, photographing date and time) forming the image group corresponding to the selected display object.

For example, as shown in FIG. 4, the initial screen in the reproduction mode is assumed to be displayed. Also, it is assumed that the user took moving image at Odaiba together with Mary and Linda three weeks ago and there are no pictures (moving-image files) taken at Odaiba other than the pictures.

In this case, in the initial screen in the reproduction mode shown in FIG. 4, for example, a finger is touched on the display object Ob1 titled “Odaiba.” In this case, there are removal of the display object Ob3 titled “Tom,” the display object Ob4 titled “one week,” the display object Ob5 titled “Shinagawa Beach Park,” and the display object Ob7 titled “Yokohama.”

Therefore, in this case, with respect to the display object Ob1 titled “Odaiba,” four display objects remain. That is to say, they are the display object Ob2 titled “Linda,” the display object Ob6 titled “three months,” the display object Ob8 titled “one month,” and the display object Ob9 titled “Mary.”

Thus, the remaining display objects mean that the user went to Odaiba along with Linda and Mary within the past one month. Oppositely speaking, they indirectly mean that the user did not go to Odaiba within the past one week, the user did not go to Odaiba with Tom, and Odaiba is different from the Shinagawa Beach Park and Yokohama.

This clearly shows to the user that the AND search can be performed between the image group corresponding to the display object selected by the user and any other image group.

It is assumed that another display object is selected among the remaining display objects. In this case, the display objects for the image groups are removed, which have only image files including no information common to references (a person's name, a name of a place, photographing date and time) forming the image group corresponding to the newly selected display object.

As such, the range in the AND search can be narrowed down. If the display objects selected in this way are operated so that they are joined together, the AND search can be performed by targeting the image groups for the display objects.

A detailed example of the AND search for image files targeting plural groups will be described.

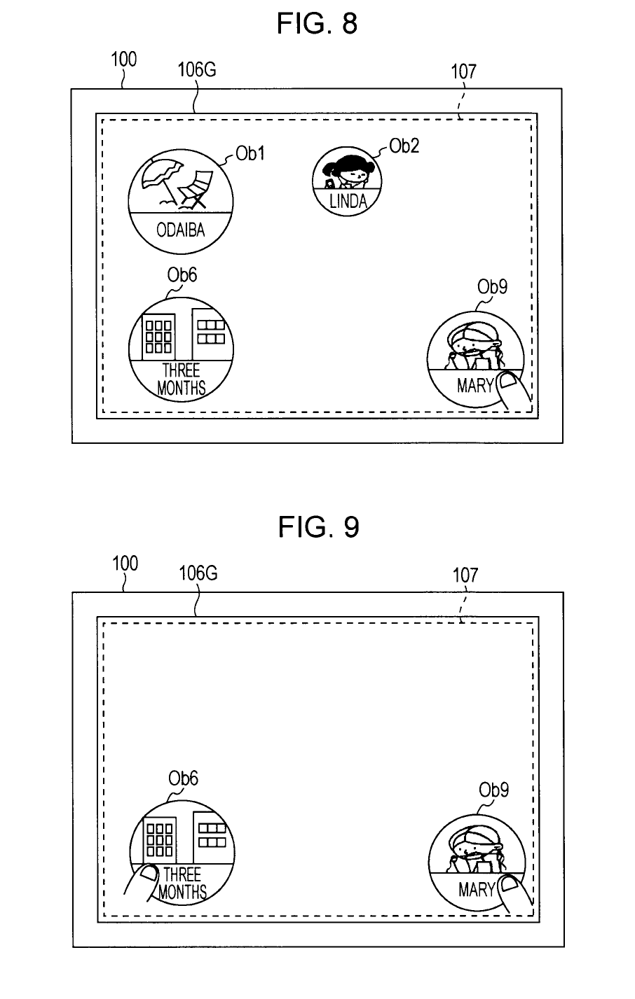

FIGS. 8 to 11 are diagrams illustrating a detailed example of the AND search for image files targeting plural groups.

In the initial mode in the reproduction mode shown in FIG. 4, a finger is assumed to be touched on the touch panel 107 at a display position of the display object Ob9 titled “Mary.” In this case, the control unit 120 refers to, based on the information for each image group configured as shown in FIG. 3, the keywords of the image files belonging to each image group, and specifies image groups to which image files having the keyword “Mary” belong.

The control unit 120 controls the display image generation unit 111 to remove the display objects of the image groups excluding the image groups to which the image files having the keyword “Mary” belong.

Thereby, in this example, as shown in FIG. 8, there are three image groups to which image files including the word “Mary” in the keywords belong.

In other words, they are image groups corresponding to the display object Ob1 titled “Odaiba,” the display object Ob2 titled “Linda,” and the display object Ob6 titled “three months,” respectively.

In the state shown in FIG. 8, the digest reproduction for moving images of the moving-image files related to the display object Ob9 titled “Mary” is performed in the image display area Ar1 of each display object.

The digest reproduction for moving-image files having the keyword “Mary” is performed in each image display area Ar1 of the display objects Ob1, Ob2 and Ob6.

In the processing in this case as well, image data or the like used for the display, as described above, has been already prepared in the display image generation unit 111. Thereby, the control unit 120 controls the display image generation unit 111 to perform the digest reproduction for only the moving-image files having the keyword “Mary.”

In the state shown in FIG. 8, the user is assumed to touch the touch panel 107 at a display position of the display object Ob6 with a finger.

In this case, the control unit 120 refers to, based on the information for each image group configured as shown in FIG. 3, the photographing date and time of image files belonging to the image group, and specifies image groups having moving-image files taken within the past three months with respect to a current point in time.

The display objects are removed except for the display object for the specified image group. In other words, only the display object for the specified image group is displayed.

Accordingly, in this example, as shown in FIG. 9, the image groups having moving-image files taken within the past three months with respect to the current point in time are only two.

The two image groups are the display object Ob6 titled “three months” and the display object Ob9 titled “Mary.” Thus, in the case of this example, there are no image files which were taken within the past three months in the display object Ob1 titled “Odaiba” and the display object Ob2 titled “Linda,” but rather there are only image files taken before that.

In the state shown in FIG. 9 as well, the digest reproduction for moving images of moving-image files related to the display object Ob9 titled “Mary” is performed in the image display area Ar1 of the display object Ob6.

Also, in the state shown in FIG. 9, the digest reproduction of image files taken within the past three month is performed in the image display area Ar1 of the display object Ob9.

If the AND search is to be actually performed in the state shown in FIG. 9, it is performed by dragging the display object Ob6 and the display object Ob9 with a finger.

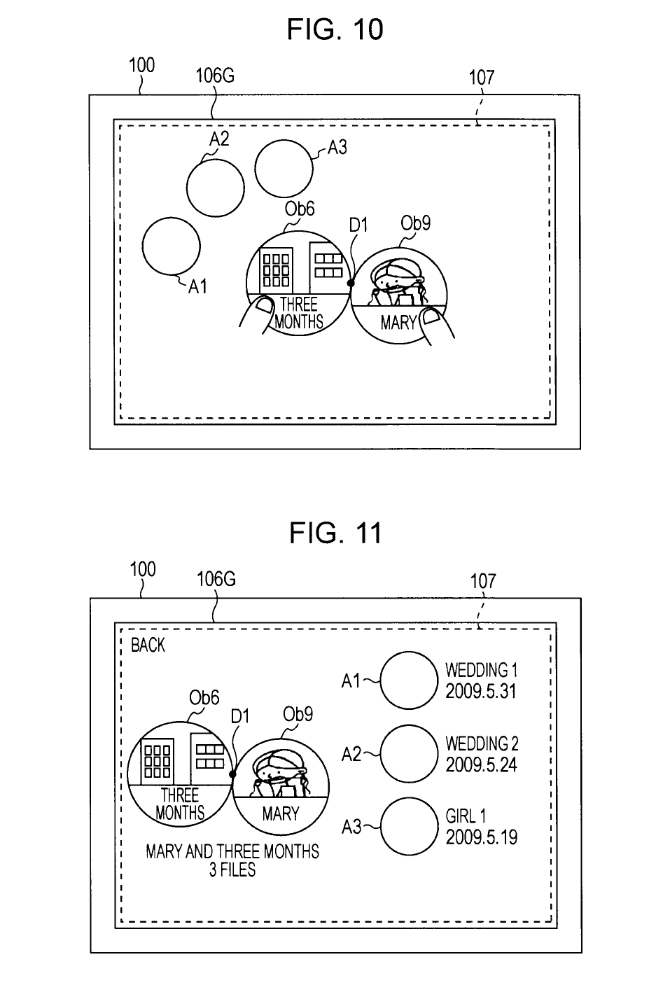

As shown in FIG. 10, the display object Ob6 and the display object Ob9 have contact with each other to join them together. The control unit 120 maintains the size or the display position of each display object. At the same time, the control unit 120 accurately grasps a touched position of a finger on the touch panel 107 based on coordinate data from the touch panel 107.

Thus, the display image generation unit 111 is controlled based on such information, the display positions of the display object Ob6 and the display object Ob9 are moved by the dragging, and both of the display objects are joined together, as shown in FIG. 10.

When the display object Ob6 and the display object Ob9 are joined together, in order to clearly notify the user of this, for example, a joining completion mark D1 marked with a black circle is displayed in the joined portion. This display can be also performed by the control unit 120 controlling the display image generation unit 111.

When the display object Ob6 and the display object Ob9 are joined together, the control unit 120 specifies moving-image files commonly included in the image group corresponding to the display object Ob6 and the image group corresponding to the display object Ob9.

In other words, the control unit 120 specifies the commonly included image files by matching the information for the image group corresponding to the display object Ob6 and the information for the image group corresponding to the display object Ob9.

In the same manner as the case of the search screen for the image files in the image group described with reference to FIG. 6, thumbnail images corresponding to the moving-image files included in both of the image groups are generated, which are displayed as shown as the thumbnails A1 to A3 in FIG. 10.

In the case of this example as well, when the number of the moving-image files included in both of the image groups is large, the number of displayed thumbnail images can be controlled depending on a pressure of a user's finger indicating the display objects.

The display in this case, in the same manner as the case described with reference to FIG. 6, may be performed in the order of the date and time of taking moving-image files, the photographing frequency for a photographing place, the photographing frequency for a person, closer/farther photographing places with respect to a current position using the GPS information, the number of persons contained in the moving-image files using the image analysis information, or the like.

The thumbnail images corresponding to the moving-image files displayed depending on the pressure may be displayed in an appropriate order based on the keywords, the photographing date and time, the GPS information, and the image analysis information, which are added to the moving-image files.

Also, it is assumed that, in the state shown in FIG. 10, the display objects Ob6 and Ob9 are dragged so that both of the display objects are apart to cancel the joining. That is to say, they return to the state shown in FIG. 9. In this case, the AND search is canceled to return to the state before the search.

If, in the state shown in FIG. 9, the user's finger, which is selecting, for example, the display object Ob6, is released from the touch panel 107, the state shown in FIG. 8 returns, and the AND search conditions may be selected again.

In other words, if any one finger is released from the touch panel 107 in the state shown in FIG. 9, the previous step returns, and the AND search conditions may be selected again.

If a constant time has elapsed after a finger touched on the touch panel 107 is released therefrom in the state shown in FIG. 10, a list display of a search result is performed as shown in FIG. 11. The list display of the search result shown in FIG. 11 has the same fundamental configuration as the list display of the search result shown in FIG. 7.

However, the display objects for the joined image groups which are search targets are displayed in the left of the display screen 106G in the joining state. This clearly shows to the user that the AND search has been performed, and the search conditions.

In the case of this example, the user selects moving-image files to be reproduced by tapping on any one of the thumbnail images A1 to A3 corresponding to the moving-image files in the list display of the displayed search result.

Thereby, the control unit 120 reads image data of the moving-image files corresponding to the tapped thumbnail image, and reproduces desired moving images using the decompression processing unit 110, the display image generation unit 111, the display processing unit 105, and the display unit 106.

In the list display of the AND search result shown in FIG. 11, all of the thumbnail images of the image files common to both of the image group corresponding to the display object Ob6 and the image group corresponding to the display object Ob9 are targeted at the display.

Therefore, if the number of the image files common to both of the image group corresponding to the display object Ob6 and the image group corresponding to the display object Ob9 is large, the thumbnail images may be scrolled in the longitudinal direction. This is the same as the list display of the search result described with reference to FIG. 7.

In the list display of the AND search result shown in FIG. 11, the selection of the icon “BACK” in the top leftmost enables the display screen to return to the initial screen in the reproduction mode shown in FIG. 4.

Also, in the examples shown in FIGS. 10 and 11, although the thumbnail images of the moving-image files are displayed in the periphery of the joined display objects, the thumbnail images may be still images, or moving images which are reproduced for a constant time.

Another Example of AND Search for Image Files in Plural Groups

At least two fingers or the like are simultaneously touched on the touch panel 107 in the AND search described with reference to FIGS. 8 to 11. However, as the case may be, the AND search may be desired to be performed using only one finger.

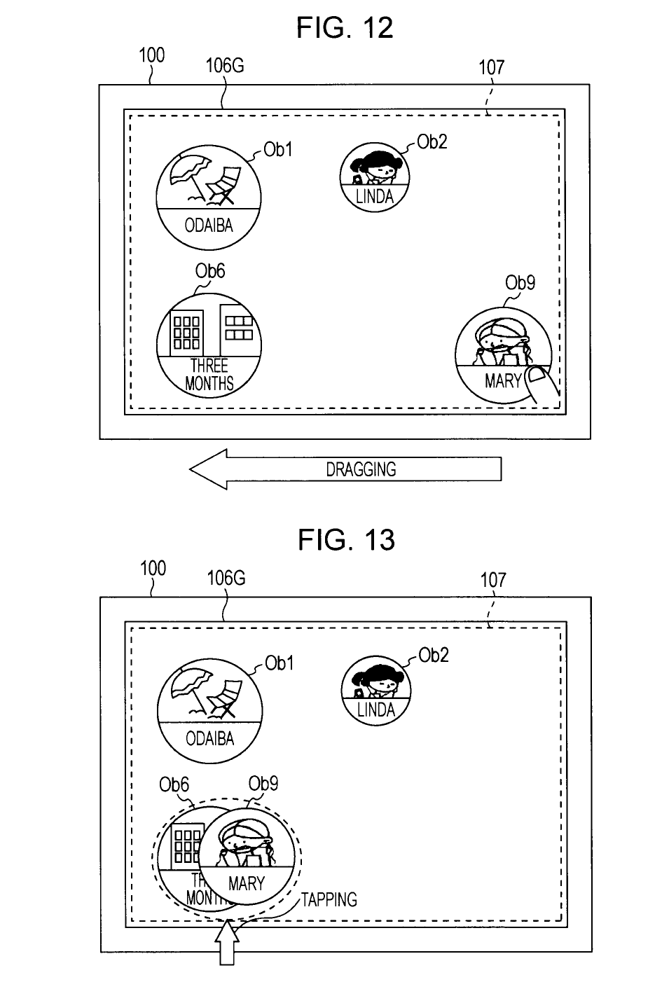

In the imaging device 100 in this example, the AND search can be performed using only one finger. An example of a case where the AND search is performed using one finger will now be described with reference to FIGS. 12 to 14.

In the case of this example as well, the point that a desired display object is initially selected in the initial screen in the reproduction mode shown in FIG. 4, thereby narrowing down the display objects as the search target, is the same as the case described with reference to FIG. 8 as shown in FIG. 12.

In other words, in FIG. 12, the state is shown where the display object Ob9 is initially selected in the initial screen in the reproduction mode shown in FIG. 4. When the AND search is performed, as indicated by the arrow in FIG. 12, the dragging is performed with a finger touching the display object Ob9 on the touch panel 107.

As shown in FIG. 13, the display object Ob9 initially selected overlaps a display object which will be selected next, in this example, the display object Ob6.

If the overlapped display objects are to be joined, the user taps on a display position of the overlapped display object Ob6 and the display object Ob9, as indicated by the arrow in FIG. 13.

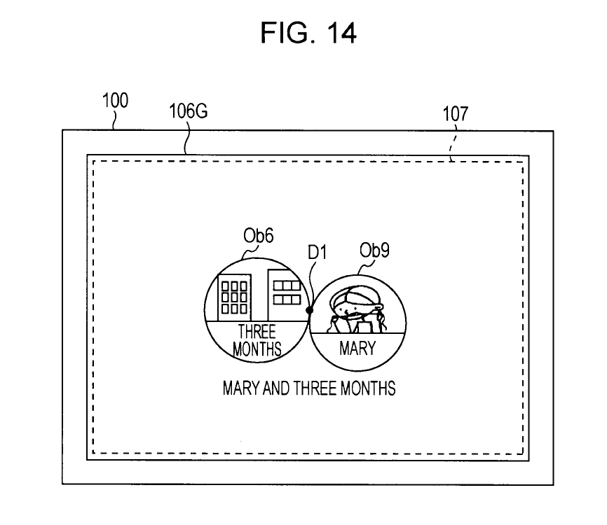

The control unit 120 recognizes the tapping on the overlapped display objects as an instruction for joining the overlapped display objects. The control unit 120 joins the display object Ob6 and the display object Ob9 together, which are instructed to be joined, to be displayed, as shown in FIG. 14.

In FIG. 14, the joining of the display object Ob6 and the display object Ob9 which are instructed to be joined is performed, and the joining of both of the display objects is indicated by the joining completion mark D1.

The control unit 120 recognizes that the display object Ob6 and the display object Ob9 have been joined together. In the state shown in FIG. 14, a finger is touched and pressed on a display position of any one of the display object Ob6 and the display object Ob9, whereby the AND search can be performed in the aspect described with reference to FIG. 10.

Thereafter, if a constant time has elapsed after the finger is released from the touch panel 107, the list display of the search result can be performed as shown in FIG. 11.

In the case of this example as well, the user selects moving-image files to be reproduced by tapping on any one of the thumbnail images A1 to A3 corresponding to the moving-image files in the list display of the displayed search result.

Thereby, the control unit 120 reads image data of the moving-image files corresponding to the tapped thumbnail image, and reproduces desired moving images using the decompression processing unit 110, the display image generation unit 111, the display processing unit 105, and the display unit 106.

In the case of the AND search described above, the AND search is performed by joining the two display objects together, but the invention is not limited thereto. The number of joined display objects may be more than one, as long as the AND search can be performed under such a condition that they have common keywords.

Summary of Processing in the Reproduction Mode in the Imaging Device 100

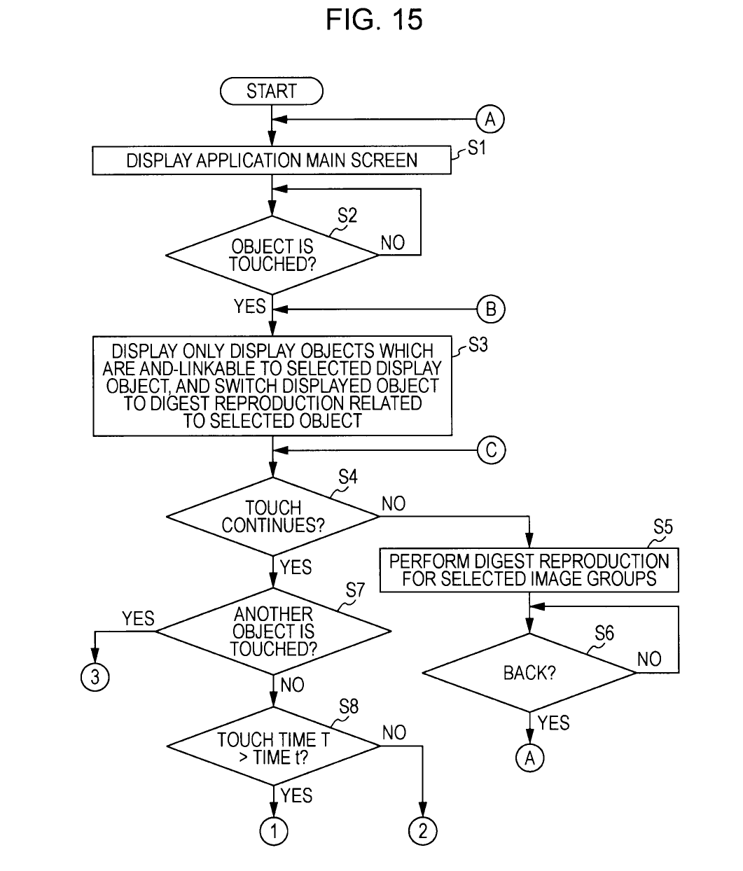

The processings in the above-described reproduction mode performed in the imaging device 100 according to this embodiment will be summarized with reference to the flowcharts in FIGS. 15 to 19. The processings shown in FIGS. 15 to 19 are mainly executed by the control unit 120 when the imaging device 100 is in the reproduction mode.

As described above, in the imaging device 100 in this embodiment, if photographing is performed, the image files are generated in the recording medium 135 according to the aspect shown FIG. 2. The image files are grouped at a predetermined timing, and the information for the image groups described with reference to FIG. 3 is generated in the recording medium 135.

When the imaging device 100 is in the reproduction mode, the control unit 120 controls the respective units based on the information for the image groups shown in FIG. 3, which is generated in the recording medium 135, and displays the application main screen (initial screen in the reproduction mode) (step S1).

The initial screen in the reproduction mode, as described above with reference to FIG. 4, is formed by the display objects corresponding to the respective image groups based on the information for the image groups. In this case, the control unit 120 controls the respective units such as the writing/reading unit 134, the decompression processing unit 110, the display image generation unit 111, and the display processing unit 105, so that the initial screen in the reproduction mode is displayed on the display screen of the display unit 106.

The control unit 120 checks coordinate data from the touch panel 107 and determines whether or not there is a touch operation (indication operation) on the display objects displayed on the display screen 106G (step S2).

When the control unit 120 determines that there is no touch operation on the display objects in the determination processing at step S2, it repeats the processing at step S2 and waits until a touch operation is performed.

When it determines that there is a touch operation on the display objects in the determination processing at step S2, the control unit 120 arranges the display of the display objects as described with reference to FIG. 8 (step S3).

In detail, at step S3, the control unit 120 displays only display objects for image groups which are AND-linkable to the display object indicated by the user.

That is to say, the control unit 120 displays only display objects for image groups which include images files having information associated with the title of the image group corresponding to the display object indicated by the user.

As described with reference to FIG. 8, when the display object titled “Mary” is selected, there is only the display of display objects of image groups having image files which include the word “Mary” in the keywords.

At the same time, at step S3, the control unit 120 performs the digest reproduction of the image files related to the display object selected by the user, in the image display area Ar1 of each of the displayed display objects.

In other words, when the display object titled “Mary” is selected, the digest reproduction is performed by sequentially reproducing images of the image files which include the word “Mary” in the keywords, in the image display area Ar1 of each of the display objects.

At step S3, the control unit 120 counts an elapse time since the user starts to touch the display object, by using the function of the clock circuit 140.

The control unit 120 determines whether or not the user continues to touch the display object (step S4).

In the determination processing at step S4, when the touch operation is determined not to be continued, the control unit 120 performs the digest reproduction for the image group corresponding to the initially selected display object, on the entire display screen 106 (step S5).

The processing at step S5 is also performed by the control unit 120 controlling the writing/reading unit 134, the decompression processing unit 110, the display image generation unit 111, the display processing unit 105, and the display unit 106.

The control unit 120 determines whether or not the icon BACK (return) is selected (step S6). In the determination processing at step S6, when the icon BACK (return) is determined not to be selected, the digest reproduction for the image group corresponding to the initially selected display object is continued, and the determination processing at step S6 is repeated.

When the icon BACK (return) is determined to be selected in the determination processing at step S6, the control unit 120 performs the processing from step S1, and enables the display screen to return to the initial screen in the reproduction mode.

When the touch operation is determined to be continued in the determination processing at step S4, the control unit 120 determines whether or not there is a touch operation (indication operation) on another display object (step S7).

The determination processing at step S7 is, as described with reference to FIG. 9, a processing of determining whether or not a plurality of display objects are simultaneously selected, that is, a so-called multi-touch operation is performed.

When it is determined that there is no touch operation on another display object in the determination processing at step S7, it is determined whether or not an elapse time T since the touch operation initially detected at step S2 is equal to or more than a preset constant time t (step S8).

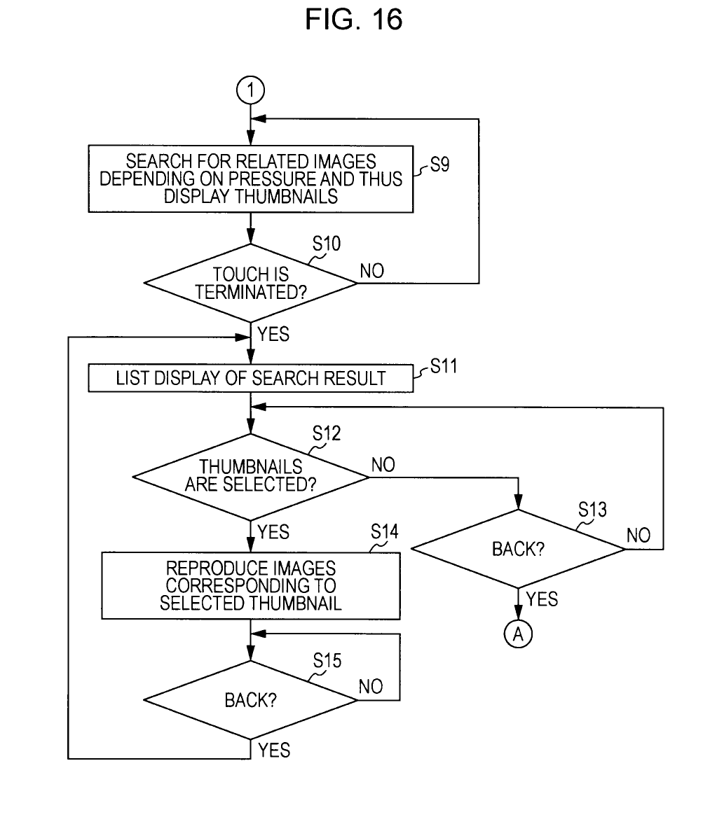

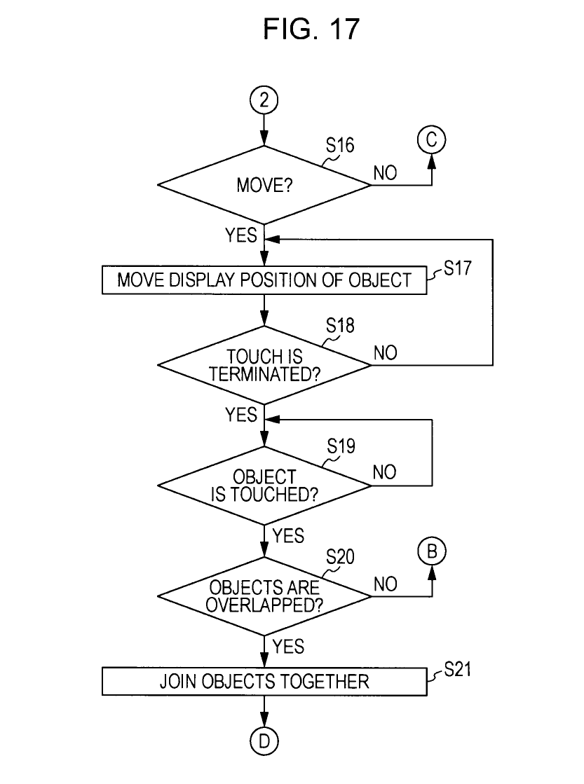

When the time T of the touch operation is determined to exceed the constant time t in the determination processing at step S8, the flows goes to the processing at step S9 shown in FIG. 16. In the determination processing at step S8, when the time T is determined not to exceed the constant time t, the flow goes to the processing at step S16 shown in FIG. 17.

When the time T is determined to exceed the constant time t in the determination processing at step S8, the control unit 120 performs the processing shown in FIG. 16, and executes the search in the image group corresponding to the display object which is continuously selected for equal to or more than the constant time t (step S9).

The processing at step S9 is the processing described with reference to FIG. 6, and the control unit 120 first displays only the display object which is continuously selected for equal to or more than the constant time t. The control unit 120 displays the thumbnail images of image files belonging to the image group corresponding to the related display object in the periphery of the display object, depending on a pressure by the user on the display screen 106G.

For example, at step S9, it is assumed that the image files are registered in the order of new photographing date and time in the information of the image group, and the display is sequentially performed from the thumbnails for the image files of which photographing date and time is new. In this case, if the display screen 106G is pressed further strongly, the thumbnail images for the image files of which photographing date and time is older are also displayed.

In contrast, for example, it is assumed that the image files are registered in the order of old photographing date and time in the information of the image group, and the display is sequentially performed from the thumbnails for the image files of which photographing date and time is old. In this case, if the display screen 106G is pressed further strongly, the thumbnail images for the image files of which photographing date and time is newer are also displayed.

The processing at step S9 is also performed by the control unit 120 controlling the writing/reading unit 134, the decompression processing unit 110, the display image generation unit 111, and the display processing unit 105, etc.

As described above, at step S9, it is possible to consider a time T when the user touches the display screen 106G with a finger, instead of the detection of pressure variation or along with the detection of pressure variation.

The control unit 120 determines whether or not the user's touch on the initially selected display object is terminated (step S10). When determining that the user's touch on the initially selected display object is not terminated in the determination processing at step S10, the control unit 120 repeats the processing starting from step S9. In this case, the search in the selected image group may be continued.

In the determination processing at step S10, when determining that the user's touch on the initially selected display object is terminated, the control unit 120 performs the list display of the search result as described with reference to FIG. 7 (step S11).

The control unit 120 determines whether or not the displayed thumbnails of the image files are selected in the list display of the search result by the user (step S12). In the determination processing at step S12, when the thumbnails are determined not to be selected, it is determined whether or not the icon BACK (return) is selected (step S13).

In the determination processing at step S13, when determining that the icon BACK (return) is not selected, the control unit 120 repeats the processing starting from step S12.

Also, in the determination processing at step S13, when determining that the icon BACK (return) is selected, the control unit 120 performs the processing starting from the step S1, and enables the display screen to return to the initial screen in the reproduction mode.

In the determination processing at step S13, when determining that the thumbnail is selected, the control unit 120 reproduces image files corresponding to the selected thumbnail (step S14).

The processing at step S14 is a processing where the control unit 120 controls the writing/reading unit 134, the decompression processing unit 110, the display image generation unit 111, and the display processing unit 105, and reads the indicated image files from the recording medium 135 to be reproduced.

Thereafter, the control unit 120 determines whether or not the icon BACK (return) is selected (step S15), and enters a waiting state by repeating the determination processing at step S15 until the icon is selected. In addition, in the determination processing at step S15, when the icon BACK (return) is determined to be selected, the processing is repeated from step S11, and the image files may be selected from the list display of the search result.

In the determination processing at step S8 shown in FIG. 15, when determining that the time T does not exceed the constant time t, the control unit 120 performs the processing in FIG. 17, and determines whether or not an operation for moving the display object is performed (step S16).

The determination processing at step S16 is a processing of determining whether or not the user's finger touching the display object is dragged, on the basis of coordinate date input through the touch panel 107.

In the determination processing at step S16, when determining that the movement operation is not performed, the control unit 120 repeats the processing starting from step S4 shown in FIG. 15.

In the determination processing at step S16, when determining that the movement operation is performed, the control unit 120 moves the display position of the selected display object on the display screen (step S17).

The processings at steps S16 to S17 correspond to those of moving the display object by the dragging, for example, as described with reference to FIG. 12.

The control unit 120 determines whether or not the touch operation on the display object is terminated (step S18). When determining that it is not terminated, the control unit 120 repeats the processing starting from step S17, and continues to perform the movement operation of the display object.

In the determination processing at step S18, when the touch operation on the display object is determined to be terminated, it is determined whether or not there is a new touch operation (indication operation) on the display objects displayed on the display screen 106G (step S19). This processing at step S19 is the same as that at step S2.

In the determination processing at step S19, when determining that there is no new touch operation, the control unit 120 repeats the processing at step S19 and waits until the new touch operation is performed.

When determining that there is new touch operation in the determination processing at step S19, the control unit 120 determines whether or not the display objects overlap each other at the touched position on the display screen (step S20).

In the determination processing at step S20, when it is determined that the display objects are not displayed to be overlapped at the touched position on the display screen by the user, since the only display object is selected, the processing starting from step S3 shown in FIG. 15 is performed.

In the determination processing at step S20, when it is determined that the display objects overlap each other at the touched position on the display screen by the user, this is determined as an operation for instructing the joining described with reference to FIG. 13.

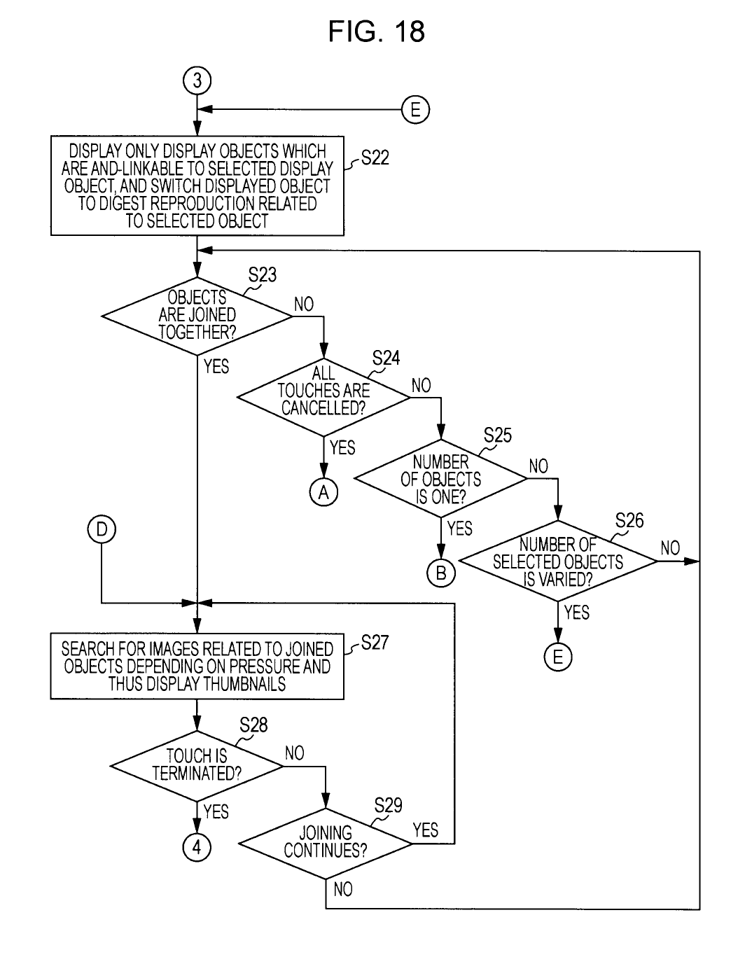

In this case, as described with reference to FIG. 14, the overlapped display objects are joined to be displayed (step S21). Next, the processing at step S27 in FIG. 18 described later is performed, and the AND search which targets the joined image groups can be performed.

In the determination processing at step S7 shown in FIG. 15, when another display object is determined to be touched, the processing shown in FIG. 18 is performed. The control unit 120 arranges the display of the display objects as described with reference to FIG. 9 (step S22).

The processing at step S22 is fundamentally the same as that at S3 shown in FIG. 15. In other words, the control unit 120 displays only display objects for AND-linkable image groups based on, for example, the initially selected display object and the subsequently selected display object.

In other words, at step S22, only display objects for AND-linkable image groups are displayed based on a plurality of display objects selected by the user.

At the same time, the control unit 120 performs the digest reproduction of image files related to the display object selected by the user in the image display area Ar1 of each of the displayed display objects.

Next, the control unit 120 determines whether or not a plurality of selected display objects is joined by the dragging, as described with reference to FIGS. 9 and 10 (step S23).

In the determination processing at step S23, when determining that the display objects are not joined, the control unit 120 determines whether or not all of the user's touch operations on the touch panel 107, which are selecting the display objects, are cancelled (step S24).

At step S24, when determining that all of the touch operations are cancelled, the control unit 120 repeats the processing starting from step S1 in FIG. 15, and enables the display screen to return to the initial screen in the reproduction mode.

In the determination processing at step S24, when determining that all of the touch operations are not cancelled, the control unit 120 determines whether or not the number of the selected display object is one (step S25).

The determination processing at step S25 is a processing of determining whether or not when, for example, two display objects are selected as shown in FIG. 9, the selection of one of the two is cancelled.

In the determination processing at step S25, when the number of the selected display object is determined to be one, the processing starting from step S3 in FIG. 15 is repeated. Thereby, there is the display of only the display object for the image group which enables the AND search along with the image group corresponding to the selected display object, thereby selecting it.

When the number of the selected display object is determined not to be one in the determination processing at step S25, it is determined whether or not the number of the display objects selected from step S23 is decreased or increased (step S26).

In the determination processing at step S26, when determining that the number of the display objects selected from step S23 is decreased or increased, the control unit 120 repeats the processing starting from the step S22. In other words, there is the display of only the display object of the AND-linkable image group based on a plurality of display objects selected by the user.

In the determination processing at step S26, when determining that the number of the display objects selected from step S23 is not decreased or increased (not varied), the control unit 120 repeats the processing starting from step S23. In other words, there is the display of only the display object of the AND-linkable image group based on a plurality of display objects selected by the user.

When a plurality of selected display objects is determined to be joined in the determination processing at step S23 and the joining processing is performed at step S21 shown in FIG. 17, the control unit 120 performs the processing at step S27.

Depending on a pressure on the display screen at the display positions of the plural joined display objects, image files regarding the joined display objects are searched, and the thumbnails corresponding thereto are displayed (step S27). This processing at step S27 is a processing described with reference to FIG. 10.

It is determined whether or not the user's touch operation on the touch panel 107 is terminated (step S28). When determining that the touch operation is not terminated in the determination processing at step S28, the control unit 120 determines whether or not the joining state of the selected display objects is maintained (step S29).

In the determination processing at step S29, when determining that the joining state is maintained, the control unit 120 repeats the processing starting from step S27, and continues to perform the AND search.

In the determination processing at step S29, when determining that the joining state is not maintained, the control unit 120 repeats the processing starting from the step S23, and handles the variation of the joining state of the display objects.

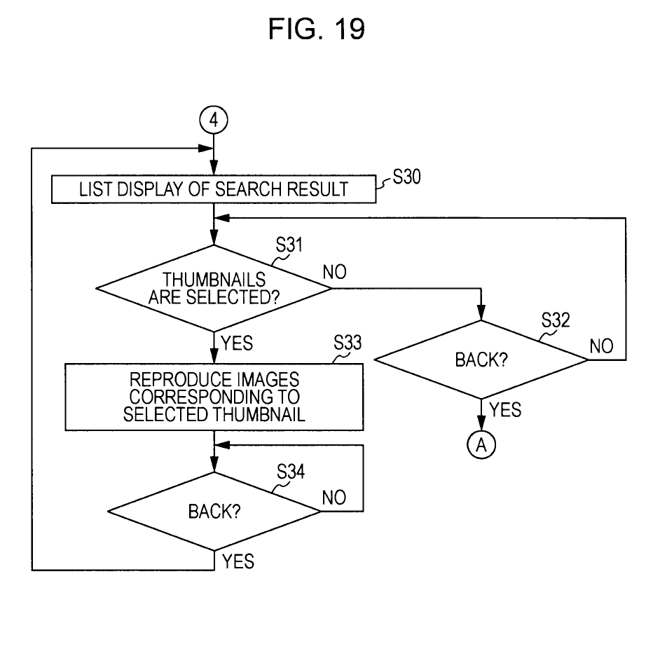

When determining that the touch operation is terminated in the determination processing at step S28, the control unit 120 performs the processing shown in FIG. 19. In addition, as described with reference to FIG. 11, the control unit 120 performs the list display of the search result (step S30).

The control unit 120 determines whether the displayed thumbnails of image files are selected by the user in the list display of the search result (step S31). When the thumbnails are determined not to be selected in the determination processing at step S31, it is determined whether or not the icon BACK (return) is selected (step S32).

When determining that the icon BACK (return) is not selected in the determination processing at step S32, the control unit 120 repeats the processing starting from step S31.

When determining that the icon BACK (return) is selected in the determination processing at step S32, the control unit 120 repeats the processing starting from step S1, and enables the display screen to return to the initial screen in the reproduction mode.

When determining that the thumbnail is selected in the determination processing at step S31, the control unit 120 reproduces image files corresponding to the selected thumbnail (step S33).

The processing at step S33 is a processing where the control unit 120 controls the writing/reading unit 134, the decompression processing unit 110, the display image generation unit 111, and the display processing unit 105, and reads the indicated image files from the recording medium 135 to be reproduced.

Thereafter, the control unit 120 determines whether or not the icon BACK (return) is selected (step S34), and enters a waiting state by repeating the determination processing at step S34 until the icon is selected. In addition, in the determination processing at step S34, when the icon BACK (return) is determined to be selected, the processing is repeated from step S30, and the image files may be selected from the list display of the search result.

In this way, in the imaging device 100 in this embodiment, as described above, the keywords indicating photographed persons or photographed places, or the like, are added to the image files obtained by photographing. In addition, the information indicating the photographing date and time is automatically added to the image files.

Thereby, in the imaging device 100, the image files are automatically grouped based on the information for “person,” “place,” “time” or the like, and thus the user can view each group so as to grasp contents of each group.

Fundamentally, by only a touch operation on the touch panel 107, it is possible to search for a desired image file, to specify the desired image file, and to reproduce the desired image file.

Therefore, at the time of the search, a burdensome operation such as inputting keywords is not performed. In addition, it is not necessary for the user to divide and store image files in folders generated by the user.

Thereby, it is possible to simply and quickly find a desired image file from a large amount of image files recorded on the recording medium.

As can be seen from the description of the above flowchart, in the case of the AND search, the number of joined display objects may be more than one, as long as the AND search can be performed under such a condition that they have common keywords.

### Effects of the Embodiment

In the embodiment described above, when desired image contents are searched from a large amount of image contents recorded on the recording medium, it is not necessary to input a complicated search condition such as character strings, or to perform an operation of a GUI menu, or the like. There is an implementation of a user interface where the contents can be simply searched by a gesture operation using one finger.

In addition, it is possible to search for the number of contents predicted by a user, depending on a pressure given to the display screen by a finger which has contact to a display object.

Not only the search in a single condition but also the AND search of combining conditions for narrowing-down can be performed intuitively and efficiently by the gesture operation.

In this case, an operation of the GUI menu or the like is not necessary, and the selection of the narrowing-down condition can be performed intuitively and efficiently by using a search condition itself shown according to the context as an operation target.

### Modified Example

In the imaging device 100 in the above-described embodiment, the invention has been applied to the case of searching for the image files recorded on the recording medium 135. However, the invention is not valid only in the search for the contents recorded on the recording medium.

For example, even when a desired item is selected from a menu, the desired item can be efficiently selected by applying the embodiment of the invention. Therefore, for example, there will be a description of a case where, in an electronic device which has multiple functions and enables various settings for each function, a desired setting in a desired function is promptly performed.

In the example described in the following, there are a function of recording and reproducing moving images (video function) and a function of recording and reproducing still images (photo function). In the imaging device 100 having the configuration shown in FIG. 1, the imaging device 100 is assumed to further have a music reproduction function and a television function.

Here, the television function is a function in which a module for receiving digital television broadcasts is provided, the digital television broadcasts are received and demodulated, and the pictures are displayed on the display screen of the display unit 106 so as to be viewed.

In addition, the music reproduction function is achieved by using a module for reproducing music stored in the recording medium 135 and for decoding selected music data. A user listens to music through speakers provided in the imaging device or through earphones connected to audio output terminals (not shown in FIG. 1).

Therefore, the imaging device 100 in this example has the module for receiving digital television broadcasts and the module for reproducing music compared with the imaging device 100 shown in FIG. 1, and the description thereof will be made with reference to FIG. 1.

It is assumed that the imaging device 100 described below is connected to various electronic devices via the external interface 132, receives and transmits various kinds of data, and sets communication environments at that time.

Such a multi-functional electronic device has been implemented by a portable telephone terminal or the like. For example, there has been also provided a portable telephone terminal which has a telephone function, an Internet access function, a function of recording and reproducing moving images, a function of recording and reproducing still images, a function of reproducing music, a function of receiving television broadcasts, or the like.

Generally, a setting for pictures such as image quality is different in each of a photo, a video, and a television. Likewise, a setting for audio data is different in each of a music reproduction, a video, and a television. However, in the current state, in a menu for selecting a setting item regarding each function, settable items are displayed as a list, so there is a problem in that a desired item is difficult to find.

Accordingly, in the imaging device 100 in this modified example, settable large items are made to be registered for each function. For example, it is assumed that, for the function of reproducing music, two items of “audio setting” and “communication setting” are settable, and, for the video function, three items of “audio setting,” “picture setting,” and “communication setting” are settable.

In addition, it is assumed that, for the television function, two items of “audio setting” and “picture setting” are settable, and for the photo function, two items of “picture setting” and “communication setting” are settable.

It is assumed that settable detailed items for the respective settable large items are registered for the respective corresponding functions. For example, it is assumed that, in the “picture setting,” as settable detailed items regarding the photo function, the detailed items such as “image size setting,” “compression ratio setting,” “noise reduction,” and “tint” are set. Also, it is assumed that, in the “picture setting,” detailed items regarding the video function or the television function are set.

Likewise, settable detailed items regarding the respective corresponding functions are set in the “audio setting” or the “communication setting.”

Based on such pre-settings, when the imaging device 100 is switched to a setting mode, the control unit 120 displays a setting screen, and enables a desired function and a desired setting item to be quickly found and set.

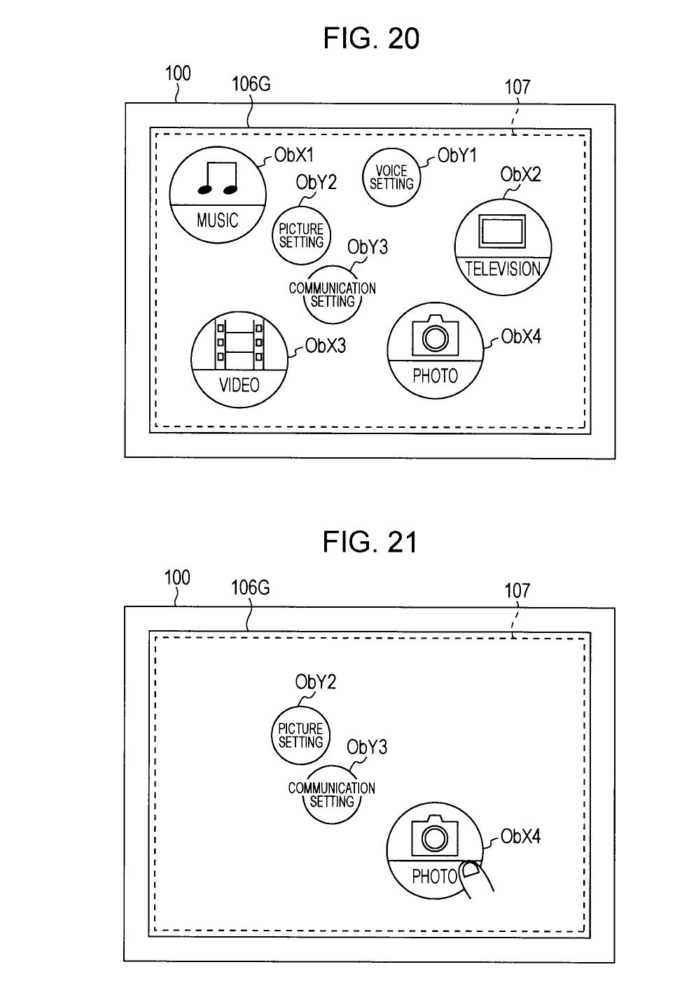

FIGS. 20 to 23 are diagrams illustrating a processing in the setting mode. The imaging device 100 in this example, when switched to the setting mode, generates and displays an initial screen in the setting mode, as described above, based on information for the settable large items for each function and information for the settable detailed items for the related large item, which are registered in advance.

In this example, FIG. 20 is a diagram illustrating an example of an initial screen in the setting mode. In FIG. 20, each of the display objects ObX1, ObX2, ObX3 and ObX4 corresponds to information for the settable large items for each function. In addition, in FIG. 20, each of the display objects ObY1, ObY2, and ObY3 corresponds to information for the settable detailed items for each large item.

Here, for example, a case will be described in which the image quality setting is performed as a setting for the photo function. As described above, for the photo function, the two items of the “picture setting” and the “communication setting” are settable. Thus, the “picture setting” and the “communication setting” correspond to the display object ObX4.

In the initial screen in the setting mode shown in FIG. 20, a finger is assumed to be touched on the touch panel 107 at a display position of the display object ObX4. In this case, the control unit 120 displays, as shown in FIG. 21, only the display object ObY2 for use in the “picture setting” and the display object ObY3 for use in the “communication setting,” based on the large items registered regarding the photo function.

The display object ObY1 for use in the “audio setting,” which has no detailed items to be set regarding the photo function, are not displayed. For this reason, even though the “audio setting” is not settable, there is no inconvenience such as selecting the display object ObY1 for use in the “audio setting.”

As described above, the setting desired by a user is the image quality adjustment, so the user touches the touch panel 107 with a finger, at the display position of the display object ObY2 for use in the “picture setting,” in the state shown in FIG. 21.

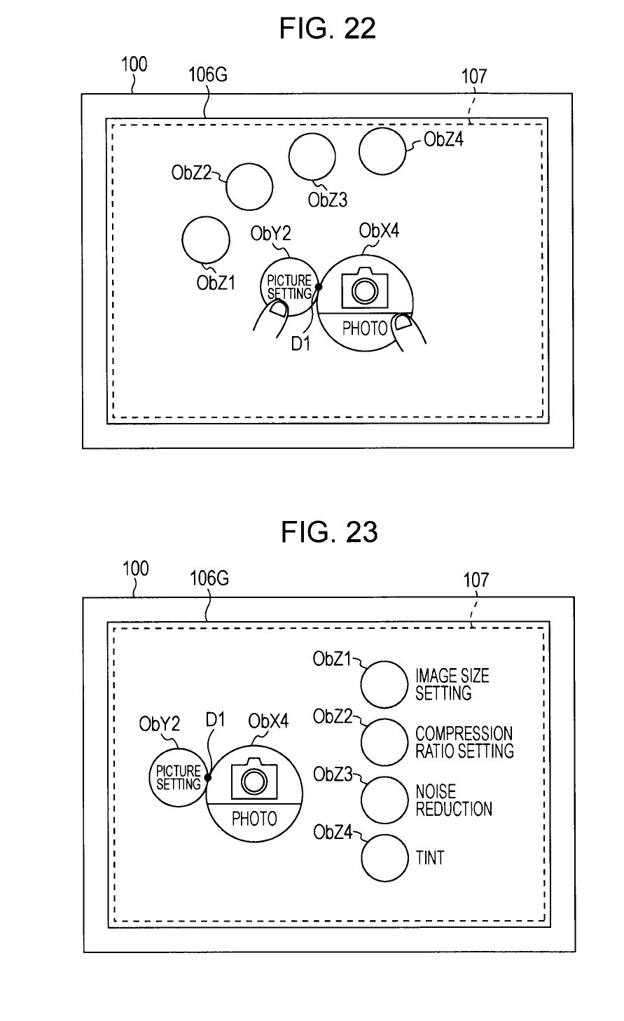

As shown in FIG. 22, both of the display objects are joined together by dragging the display objects ObX4 and ObY2 with fingers or the like touching on the display.

In this case, the control unit 120 displays objects for the above-described “image size setting,” “compression ratio setting,” “noise reduction,” and “tint,” which are the detailed items belonging to the “picture setting” and have been set as the settable detailed items in the “photo function.”

In FIG. 22, the object ObZ1 is related to the “image size setting,” and the object ObZ2 is related to the “compression ratio setting.” Also, the object ObZ3 is related to the “noise reduction,” and the object ObZ4 is related to the “tint.”

As the object ObZ1, the object ObZ2, the object ObZ3, and the object ObZ4, an illustration image or the like corresponding to each of them is displayed.

It is possible to control the number of the objects corresponding to the detailed items by varying a pressure given to the display screen, which is thus useful in the case of searching for a desired detailed setting item when there are many settable detailed items.

Thereafter, if the user releases the finger from the touch panel 107, the control unit 120 performs a list display of a search result shown in FIG. 23. In the list display of the search result shown in FIG. 23, one of the object ObZ1, the object ObZ2, the object ObZ3, and the object ObZ4 is selected. The control unit 120 enables the screen to be changed to a screen for setting the selected detailed item.

The user can set a desired detailed item using the screen for setting the related detailed item.

In this way, even when the desired setting is performed, the user just selects a certain setting for a certain function via the touch panel, thereby reliably specifying a settable detailed item, and performing a desired setting accurately and quickly.

Not only multimedia devices are increased but also the number of setting items which are set in one device is increased; however, the mechanism is provided which shows only related setting items such that the user efficiently reaches a desired item.

In the modified example described with reference to FIGS. 20 to 23, the fundamental processing is performed in the same manner as the processing in the flowcharts shown FIGS. 15 to 19. That is to say, when switched to the setting mode, the initial screen (FIG. 20) in the setting mode is displayed (step S1), and the subsequent processing is performed in the same manner as that shown in FIGS. 15 to 19.

### Method and Program According to an Embodiment of the Invention

As can be seen from the description of the above embodiment, in the imaging device 100, the image files recorded on the recording medium 135 are grouped to generate image groups, the display image generation unit 111 or the like controlled by the control unit 120 generates the display objects assigned to the respective image groups, and the display objects assigned to the respective image groups are displayed on the display screen of the display unit 105 by the control unit 120 and the display image generation unit 111 in cooperation.

A display processing method according to an embodiment of the invention includes, a grouping process where a grouping mechanism groups such that each of a plurality of selectable items belongs to one or more groups based on information which each item has, an assigning process where an assigning mechanism generates and assigns display objects corresponding to related items to the respective groups generated by the grouping of the plurality of selectable items in the grouping process, and a display processing process where a display processing mechanism displays the display objects assigned to the groups in the assigning process, on a display screen of a display element.

In FIG. 1, the functions of the decompression processing unit 110 and the display image generation unit 111 marked with the double line can be implemented by the control unit 120. Thereby, a display processing program according to an embodiment of the invention, which is a computer readable program executed in the control unit 120, using a computer mounted in a display processing device, includes, a grouping step grouping such that each of a plurality of selectable items belongs to one or more groups based on information which each item has, an assigning step generating and assigning display objects corresponding to related items to the respective groups generated by the grouping of the plurality of selectable items in the grouping step, and a display processing step displaying the display objects assigned to the groups in the assigning step, on a display screen of a display element.

The method described with reference to the flowcharts in FIGS. 15 to 19 is the detailed display processing method according to an embodiment of the invention, and the program created in accordance with the flowcharts in FIGS. 15 to 19 is the detailed display processing program according to an embodiment of the invention.

Others

In the above-described embodiment, the control unit 120 implements the function of the grouping mechanism, the display image generation unit 111 mainly implements the function of the assigning mechanism, and the control unit 120 and the display image generation unit 111 mainly implement the function of the display processing mechanism.

The display unit 106 and the touch panel 107 implement the functions of the selection input reception mechanism and the selection mechanism. The control unit 120 and the display image generation unit 111 mainly implement the functions of the item display processing mechanism, the list display processing mechanism, and the first and second display control mechanisms.

In addition, the control unit 120 and the display image generation unit 111 mainly implement the functions of the object display control mechanism and the image information display control mechanism.

In the above-described embodiment, the indication input from the user is received via the touch panel 107, but the invention is not limited thereto. It is also possible to receive the indication input by, for example, performing the indication input using a pointing device such as a so-called mouse, or moving a cursor using the arrow keys or the like provided in a keyboard.

Although the case where the imaging device mainly handles moving-image files in the above-described embodiment has been described as an example, the invention is not limited thereto. The handled data may be not only moving-image files, but also still image files, audio files such as music contents having thumbnail images or illustration images, text files, game programs, or the like.

Although the case where the above-described embodiment is applied to the imaging device has been described as an example, the invention is not limited thereto. The embodiments of the invention is applicable to an electronic device which handles various contents, or an electronic device which has multiple functions, in which various kinds of settings are necessary.

In detail, the embodiments of the invention is fit for use in a portable telephone terminal, a game machine, a personal computer, a reproducing device or recording/reproducing device using various recording media, a portable music reproducing device, or the like.

The present application contains subject matter related to that disclosed in Japanese Priority Patent Application JP 2009-173967 filed in the Japan Patent Office on Jul. 27, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display processing device comprising:
a display element;
a grouping means for grouping such that each of a plurality of selectable items belongs to one or more groups based on information which each item has;
an assigning means for generating and assigning display objects corresponding to related items to the respective groups generated by the grouping of the plurality of selectable items by the grouping means; and
a display processing means for displaying the display objects assigned to the groups by the assigning means on a display screen of the display element.

2. The display processing device according to claim 1, further comprising:
a selection input reception means for receiving a selection input of the display objects displayed on the display screen of the display element; and
an item display processing means for performing display regarding the selectable items belonging to the group corresponding to the selected display object, when the display object displayed on the display screen of the display element is selected for a constant time via the selection input reception means.

3. The display processing device according to claim 2, wherein the item display processing means changes the number of the selectable items which are display targets, in accordance with an aspect of the selection input received from a user via the selection input reception means.

4. The display processing device according to claim 2 or 3, further comprising:
a list display processing means for displaying a list regarding the selectable items displayed by the item display processing means, when the selection input of the display objects performed via the selection input reception means is completed.

5. The display processing device according to claim 1, further comprising:
a selection input reception means for receiving a selection input of one or more display objects among the display objects displayed on the display screen of the display element; and
a first display control means for controlling such that, when the selection input of display objects displayed on the display screen of the display element is received via the selection input means, only the selected display object, and the display object are displayed which include selectable items having information the same as information which selectable items assigned to the selected corresponding display object.

6. The display processing device according to claim 5, further comprising:
a second display control means for displaying, on the display screen of the display element, the selectable items having the same information among the selectable items assigned to two or more selected display objects, when the two or more display objects are selected via the selection input reception means and are joined together.

7. The display processing device according to claim 6, wherein the second display control means changes the number of the selectable items which are display targets, in accordance with an aspect of the selection input received from a user via the selection input reception means.

8. The display processing device according to claim 6 or 7, further comprising:
a list display processing means for displaying a list regarding the selectable items displayed by the second display control means, when the selection input of the display objects performed via the selection input reception means is completed.

9. The display processing device according to any one of claims 1 to 8, wherein the selectable items are image data stored in a storage means.

10. The display processing device according to claim 1, wherein the selectable items are image data stored in a storage means, and
wherein the information which each item has, which is a reference of the grouping, is one or more of information for a time, information for a person, and information for a place.

11. The display processing device according to claim 1, wherein the selectable items are image data stored in a storage means,
wherein the display object is provided with a display area of images, and
wherein the display processing device further comprises an object display control means for sequentially displaying images by image data belonging to the corresponding group in the corresponding display area.

12. The display processing device according to claim 1, wherein the selectable items are image data stored in a storage means, and
wherein the display processing device further comprises:
a selection means for selecting the display objects; and
an image information display control means for sequentially displaying images by image data belonging to the group corresponding to the display object selected via the selection means on the display screen of the display element.

13. The display processing device according to claim 3, wherein the selectable items are image data stored in a storage means, and
wherein the item display processing means controls a display order of the displayed items based on any one of information for a time, information for a person, and information for a place.

14. The display processing device according to claim 5, wherein the selectable items are image data stored in a storage means, and
wherein the display object is provided with a display area of images, and
wherein the display processing device further comprises an object display control means for displaying images by image data belonging to the group corresponding to the display object selected via the selection input reception means in the corresponding display area.

15. The display processing device according to any one of claims 1 to 8, wherein the selectable items are items corresponding to each of executable functions.

16. A display processing method comprising the steps of:
grouping such that a plurality of selectable items each of which belongs to one or more groups based on information which each item has, by a grouping means;
generating and assigning display objects corresponding to related items to the respective groups generated by the grouping of the plurality of selectable items in the step of grouping, by an assigning means; and
displaying the display objects assigned to the groups in the step of assigning on a display screen of a display element, by a display processing means.

17. A computer readable display processing program enabling a computer mounted on a display processing device to execute the steps of:
grouping such that a plurality of selectable items each of which belongs to one or more groups based on information which each item has;
generating and assigning display objects corresponding to related items to the respective groups generated by the grouping of the plurality of selectable items in the step of grouping; and
displaying the display objects assigned to the groups in the step of assigning, on a display screen of a display element.

18. A display processing device comprising:
a display element;
a grouping mechanism configured to group such that each of a plurality of selectable items belongs to one or more groups based on information which each item has;
an assigning mechanism configured to generate and assign display objects corresponding to related items to the respective groups generated by the grouping of the plurality of selectable items by the grouping mechanism; and
a display processing mechanism configured to display the display objects assigned to the groups by the assigning mechanism on a display screen of the display element.
